(19) United States
(12) Patent Application Publication
(10) Pub. No.: US 2017/0015545 A1
(43) Pub. Date: Jan. 19, 2017

(54) REFILLABLE CONTAINER WITH A ZERO WASTE DISPENSING SYSTEM

(71) Applicant: PACK FLOW CONCEPTS LLC, Pittsford, NY (US)

(72) Inventors: Stephen DERBY, Troy, NY (US); John McFadden, Fairlee, VT (US); David BROWN, Pittsford, NY (US); Eugene ECKERT, Hamburg, NJ (US)

(21) Appl. No.: 15/005,813

(22) Filed: Jan. 25, 2016

Related U.S. Application Data
(63) Continuation-in-part of application No. 14/004,203, filed on Sep. 10, 2013, now abandoned.
(60) Provisional application No. 61/462,971, filed on Feb. 10, 2011.
(60) Provisional application No. 61/516,804, filed on Apr. 8, 2011.

(51) Int. Cl. B67D 7/14; B65D 6/16; B67D 7/02; B65D 35/30; B65D 77/06; B65D 8/00; B65D 23/08

(52) U.S. Cl. CPC B67D 7/145; B65D 11/04; B65D 11/18; B65D 23/0885; B65D 35/30; B65D 77/06; B67D 7/02

(57) ABSTRACT

The refillable container includes a semi-rigid outer shell that defines an interior void and includes a detachable pour spout. The container may be refilled with a plurality of collapsible inserts. Instead of rigid beverage bottles and other flowable substance containers, the collapsible inserts may be transported from a manufacturing to a filling facility in a collapsed state, and do not have to include semi-rigid materials thereby minimizing disposal requirements. A tilt-pouring embodiment, a helical track embodiment, a helical axle embodiment and an air-bladder embodiment of refillable containers having common components permit dispensing of products from the containers to achieve virtually zero waste of the products.

### CROSS REFERENCE TO RELATED APPLICATIONS

This application is a continuation in part of U.S. patent application Ser. No. 14/004,203 filed on Sep. 10, 2013, which is the National Stage of International Application No. PCT/US2012/024620, having an International Filing Date of Feb. 10, 2012, which designated the United States of America, and which International Application was published under PCT Article 21(2) as WO Publication No. 2012/109525 A1, and which claims priority from and the benefit of U.S. Provisional Patent Application No. 61/516,804, filed on Apr. 8, 2011 and U.S. Provisional Patent Application No. 61/462,971, filed on Feb. 10, 2011, the disclosures of which are incorporated herein by reference in their entireties.

### BACKGROUND

1. Field

This disclosure relates to structures for containing and pouring liquids and flowable substances (such as fruit juice, soda, laundry detergent, kitty litter, pelletized animal food, etc.), and in particular relates to a refillable, reusable container that receives and secures a collapsible insert that contain the liquids or flowable substances.

2. Brief Description of Related Developments

It is well known that traditional containers for dispensing liquids and flowable substances are generally blow-molded bottles made of varying types of thermoplastics. Every supermarket has literally hundreds of different types of such semi-rigid bottles to contain all types of common household products. Typically the bottles are manufactured in a first manufacturing facility, and then shipped to a second facility for filling and sealing prior to distribution to a third retail sales type of facility.

Very substantial transportation and handling costs are involved with processing such semi-rigid bottles from a manufacturing plant to a filling plant. For example, and as shown schematically in FIGS. 4 and 5, prior art handling of empty bottles being delivered from manufacturing to filling facilities may involve the costs of palletizing and securing the bottles 10 on separate pallets 12, or it is also common to simply transport the bottles 10 within a box-like bottle container 14 shown in FIG. 5. Upon arrival at a filling facility the bottles 10 must then be individually processed through filling machinery. It is apparent that the costs of transporting large, light empty containers combined with the costs of separating the empty containers for processing during filling is a very substantial component of the overall costs of manufacture and delivery of such liquids and flowable substances to an end user.

Moreover, the need to form such containers into semi-rigid bottles 10 is mandated by requirements for retail display of the containers as well as of automated machinery that transfers the delivered, new bottles into filling and distribution machinery. This gives rise to grave environmental concerns. Because the bottles 10 must have adequate structural integrity to withstand the described processing, including retail display, the bottles 10 invariably pose environmental challenges. While expensive and time-consuming efforts are being undertaken to recycle and reuse the materials of these semi-rigid plastic bottles, it is apparent that recycling will never be completely successful, and used semi-rigid plastic containers continue to pollute our environment in ever greater quantities.

Accordingly, there is a need for an improved, more efficient, and more environmentally friendly system for manufacture, filling and distribution of containers for liquids and flowable substances.

### SUMMARY

The disclosure includes a refillable container with a zero waste dispensing system. In one embodiment, the refillable container has a semi-rigid outer shell that defines an interior void. The container also includes a detachable pour spout adjacent a top end of the shell and adjacent a top end of the interior void. A collapsible insert is dimensioned to be selectively secured within the interior void of the semi-rigid outer shell and is also dimensioned to be selectively removed from the semi-rigid outer shell. The collapsible insert and outer shell are cooperatively formed to permit selective pouring of the substance through the pour spout out of the shell. The collapsible insert includes a securing coupler affixed to a top end of the insert and the coupler is configured to be mechanically engage the pour spout of the semi-rigid outer shell. The securing coupler also forms a fill fitting configured to mate with an automated filler before the collapsible insert is positioned within the semi-rigid outer shell.

A base fixture is secured to a bottom end of the collapsible insert opposed to the top end of the insert, and the base fixture is constructed to engage and be selectively secured to a bottom end of the semi-rigid outer shell. This prevents the collapsible insert from collapsing or folding during pouring of a pourable substance out of the insert through the securing coupler and pour spout of the shell. The secured base fixture thereby provides for zero waste while the substance is poured out of the collapsible insert.

An end user would acquire one semi-rigid outer shell, and then purchase multiple collapsible inserts that are filled with product to be secured within the void of the shell one at a time. When a first collapsible insert is empty, it would be removed and a second collapsible insert would replace it within the outer shell. Because the collapsible insert does not have to be manufactured with adequate structural integrity to stand on its own, such as within a retail display of ketchup, juice, milk, or detergent bottles, etc., the collapsible inserts can be readily manufactured of biodegradable materials, or at least will have a smaller amount of traditional packaging materials.

Additionally, the present disclosure includes manufacture of the collapsible inserts so that they may be transported from a place of manufacture to a place of filling in a collapsed state. This alone provides for enormous cost savings in the processing of containers for flowable goods. In another embodiment, collapsible inserts may be manufactured in strips with a predetermined number of inserts secured to each other in a side-by-side arrangement. The inserts may be manufactured so that base fixtures of the collapsible inserts are also joined together side-by-side to form a packet of three or more collapsible inserts. This will facilitate processing of the collapsible inserts through automated machinery utilized in transporting, separating and filling the inserts, as well as in adding structural integrity for retail display. For example, instead of one collapsible, filled insert standing alone, which would be difficult, three or more may have tear-separable base fixtures and/or tear-separable securing couplers to facilitate support of, for example, a square of four inserts, or a six-pack of six inserts, all of which may be mutually supported within a common retail-display sheathing.

Alternatively, instead of tear-separable base fixtures and/or securing couplers, the base fixtures of the collapsible inserts may be secured within a holding tray configured to selectively secure the base fixtures of a plurality of collapsible inserts. Such holding trays may be utilized to facilitate processing of the collapsible inserts from manufacture, through filling to retail display. The holding trays may also include structures on opposed support surfaces of the holding trays to secure both the base fixtures of a first set of collapsible inserts and the securing couplers of a second set of collapsible inserts, so that trays of collapsible inserts may be stacked upon each other. Such stacking of layers of collapsible inserts may be utilized when the inserts are empty and collapsed, or filled and expanded. It is anticipated, that stacked trays of a plurality of filled inserts may be efficiently utilized for retail display at large, end-of-aisle displays in “big-box” types of retail-sales facilities, etc.

In a further embodiment the present disclosure includes a refillable container with a zero waste dispensing system for non-pourable liquids, such as lotions, pastes and other highly viscous substances, and ordinary liquids. This thick-liquid embodiment also includes a semi-rigid outer shell defining an interior void and a discharge cap adjacent a top end of the shell. A collapsible insert is also included and is dimensioned to be selectively inserted into and removed from the interior void of the shell. The collapsible insert includes a securing coupler that is configured to mate with and mechanically engage the discharge cap of the shell. Instead of relying upon the force of gravity to pour the contents out of the insert upon tipping of the container, as with the above described container for flowable substances, the thick-liquid embodiment utilizes varying efficient but complex extractions mechanisms to move the thick liquid and ordinary liquid within the insert through the discharge cap and out of the container. The thick-liquid embodiments may not just dispense highly viscous liquids, but can also dispense those and ordinary liquids at precisely measured doses through use of a ratchet-based mechanical drive. Each click of a ratchet mechanism can be calibrated to dispense a precise amount. The disclosure includes use of a pointer and a dosing or measured amount indicator linked to the ratchet mechanism for sensitive dispensing of contained products.

A first extraction mechanism includes at least one or two and preferably three helical tracks defined upon an inside surface of the semi-rigid outer shell. (For purposes herein, the phrase “helical track” is intended to include both a groove defined to descend below the inside surface of the shell as well as a ridge defined to extend above the inside surface of the shell. It is expected that most embodiments of the helical track will be in the form a groove.) The helical tracks may define endless loops that ascend from a place of beginning of the tracks adjacent the bottom end of the rigid shell at a modest angle toward the top end of the shell and then descend at a very acute angle back to the bottom of the shell to the place of beginning of the helical tracks. An elevator platform is configured to fit within the interior void of the shell and the elevator platform includes pins projecting away from the platform and into or onto the helical tracks.

The collapsible insert is placed upon the elevator platform and the securing coupler is secured to the discharge cap of the reusable container. Rotation of the elevator platform relative to the semi-rigid outer shell, or rotation of the semi-rigid outer shell relative to the elevator platform causes the platform pins to move along the upward ascending helical tracks to thereby force the non-flowable liquid out of the collapsible insert through the discharge cap. A ratchet mechanism may be included so that each rotation of either the platform relative to the shell or the shell relative to the platform causes a predetermined increment of highly viscous liquid to pass through the discharge cap. The ratchet mechanism also prohibits descent of the elevator platform after an incremental ascent. One embodiment includes only multiple revolutions of the helical track about the rigid shell as the platform ascends upward toward the top of the shell. When the collapsible insert reaches adjacent the top of the shell, it is then empty, and the insert may be removed from the shell and the elevator platform returned to the bottom of the shell. Another embodiment includes the multiple revolutions of the helical track about the perimeter of the rigid shell, and also includes about one-half of one revolution about the shell for the platform to return from the top to the bottom of the interior void of the shell. This facilitates rapid re-expansion of the collapsible insert so that the user knows when the insert is empty and will not damage the rotating mechanism.

This rapid return feature of the helical track also promotes zero waste dispensing because the consumer is clearly informed by the rapid return mechanism when the collapsible insert is emptied. The described refillable container for non-flowable liquids therefore provides an extremely high efficiency of complete usage of the liquids compared to known technologies for dispensing non-flowable liquids. For example, traditional hand-lotion dispensers utilize a plunger pump which invariably ends up leaving ten percent or more of the lotion adhered to interior walls and the bottom of the dispenser after the plunger pump is incapable of developing suction. Similarly, even rolled up tooth-paste tubes are incapable of dispensing all of their contents, while most are not even rolled up. This thick-liquid embodiment also avails itself of the aforesaid advantages of utilizing replaceable, collapsible inserts of the non-flowable or thick liquid.

A further embodiment of the thick liquid refillable container includes use of the aforesaid elevator platform mechanism for barely flowable substances such as coffee by rotating the container so that it is upside down. Then the relative rotation of the elevator platform is activated while a user holds and possibly shakes the outer shell while holding a measuring cup under the discharge cap. The thick liquid embodiments using a ratchet mechanism also obtains a very substantial advantage in effectively eliminating any back flow or suction force into their discharge caps. Traditional thick-liquid dispensers, from lotion bottles with plunger pumps to tooth paste tubes, slightly re-expand after usage permitting atmosphere or other contaminants into the discharge caps and containers. Use of the ratchet mechanism in the present disclosure prevents entry of air back into the container and thereby enhances preservation of the quality of the contents of the refillable container.

In an additional embodiment of the refillable container, an alternative extraction mechanism may involve applying force to one or more sides of the collapsible insert. A first side-force extraction mechanism utilizes a semi-rigid outer shell that defines an interior void into which a collapsible insert is positioned and secured by a securing coupler affixed to a discharge cap of the outer shell. In this embodiment one or more compression plates are secured within the interior void and are secured within the interior void by one or preferably more helical axles that define helical tracks about the exterior surfaces of the axles. The axles extend between and they are supported by side walls of the semi-rigid outer shell. The axles pass through corresponding axle slots in the compression plates to support the compression plates in varying positions.

For example, a gearing mechanism allows the helical axles to rotate upon rotation of a drive mechanism that extends from the side wall of the outer shell so that rotation of the helical axles forces the compression plates away from the side walls of the outer shell toward each other. In use of this embodiment, as the compression plates are adjacent the side walls of the shell, a collapsible insert of a thick liquid, or any liquid, is inserted within the shell between the compression plates so that the securing coupler of the insert engages a discharge cap of the shell. The drive mechanism may also include a one-way ratchet device so that the rotation of the helical axles by the drive mechanism causes compression of the collapsible insert and discharge of a predetermined quantity of the contents of the insert out of the container. By utilizing uniform, incremental compression of the insert by the compression plates, no waste product remains within the insert. As with the aforesaid embodiments, this thick-liquid, compression plate embodiment includes the many benefits of a replaceable, collapsible insert, and use of the ratchet mechanism to restrict entry of air or other contaminants into the container.

In an additional embodiment the compression plates may be activated to move toward each other and force the contents of a thick liquid, or any liquid out of the compressible insert by one or more air bladders that are secured between the compression plates and the sides of the semi-rigid outer shell. In an additional embodiment, the one or more air bladders are secured between the compressible insert and the sides of the semi-rigid outer shell. This embodiment may include a pneumatic controller that permits, or pumps in a flow of compressed air into the bladders to measure out predetermined amounts of the thick liquid, or any liquid, through a discharge spout. This embodiment may also include pressure sensor that is configured to measure the pressure inside the collapsible insert and provide the pressure measurement to the pneumatic controller. This embodiment may also include a user display that is configured to allow a user to input a preset pressure and a display means, such as LCD or any other suitable display, to display the preset and actual pressure for the collapsible insert.

In a further embodiment the present disclosure includes a collapsible insert for retaining a flowable substance or beverage. The collapsible insert includes laminated sheets that are heat sealed forming a pouch and includes a fill fitment on the top and a pour spout fitment on the bottom of the pouch. The fill fitment allows a flowable substance or beverage to flow into the collapsible insert and the pour spout fitment allows the flowable substance or beverage to flow out of the collapsible insert. A angle seam is formed towards the bottom of the collapsible insert and causes the flowable substance or beverage to flow towards the pour spout fitment.

In yet a further embodiment the present disclosure includes a filling station and filling station kit for filling the collapsible insert with a flowable substance or beverage from a tap. The filling station includes a collapsible insert, support structure configured to support the collapsible insert, a tap that is configured to flow a flowable substance or beverage from the tap to the collapsible insert and a tap on/off switch that is configured to turn the tap off when the collapsible insert is filled and keep the tap on when the collapsible insert is being filled. The filling station may also include a drain tube that allows any excess flowable substance or beverage to flow out of the collapsible insert and a fill tube that allows the flowable substance or beverage to flow into the collapsible insert.

In yet a further embodiment the present disclosure includes a method for remotely distributing a flowable substance or beverage. The method includes an online system that displays available flowable substances or beverages that a consumer may order, where the consumer to selects the selected flowable substance or beverage and places an order, the order is transmitted to either a remote or local filling and distribution source and the remote or local filling sources are provided with a combination of collapsible inserts, refillable containers and station support structures. The remote and local filling and distribution sources receive the order from the on line distribution system and fill the collapsible inserts. The remote filling and distribution source may deliver the filled collapsible insert and the refillable containers to either the local filling and distribution source or directly to the consumer. The local filling and distribution source may deliver the filled collapsible and refillable containers inserts directly to the consumer.

Accordingly, it is a general purpose of the present disclosure to provide a refillable container with a zero waste dispensing system that overcomes deficiencies of the prior art.

It is a more specific purpose to provide a refillable container with a zero waste dispensing system that minimizes manufacturing and transportation costs of packaging and delivering liquids, thick liquids and other flowable substances while substantially reducing environmental burdens associated with manufacture, distribution and use of known containers for liquids, thick liquids and other flowable substances.

These and other purposes and advantages of the present refillable container with a zero waste dispensing system will become more readily apparent when the following description is read in conjunction with the accompanying drawings.

### BRIEF DESCRIPTION OF THE DRAWINGS

FIGS. 1A-1F are a sequence of simplified plan drawings (FIG. 1A-FIG. 1E) and a perspective drawing (FIG. 1F) showing steps in using a refillable container with a zero waste dispensing system constructed in accordance with the present invention and showing insertion of a collapsible insert within an interior void of a semi-rigid outer shell of the disclosure.

FIG. 2 is a perspective view of a collapsible insert of the present disclosure showing a securing coupler and base fixture at opposed ends of the insert.

FIG. 3 is top plan view of three optional arrangements of groups of collapsible inserts and holding trays for securing the inserts relative to each other.

FIG. 4 is a schematic representation of prior art stacked pallets of empty semi-rigid, plastic bottles.

FIG. 5 is a schematic representation of a prior art bottle container for holding and transporting semi-rigid plastic bottles.

FIG. 6 is a side plan view of a plurality of collapsible inserts secured in a side-by-side arrangement by a holding tray.

FIG. 7 is a side plan view of the FIG. 6 collapsible inserts in a holding tray and showing additional pluralities of collapsible inserts stacked upon additional holding trays.

FIG. 8 is a simplified, schematic representation of the FIG. 6 plurality of collapsible inserts commencing engagement of fill fittings of the inserts with a lift device.

FIG. 9 is a simplified, schematic representation of the FIG. 8 lift device engaging all fill fittings of the plurality of collapsible inserts.

FIG. 10 is a simplified, schematic representation of a fill device positioned over the FIG. 9 plurality of collapsible inserts after the FIG. 8 lift device has lifted and expanded the collapsible inserts.

FIG. 11 is a simplified, schematic representation of the FIG. 10 fill device showing the fill device inserted through fill fittings of the collapsible inserts to fill the expanded inserts.

FIG. 12 is a simplified, schematic representation of the FIG. 11 plurality of expanded, filled, collapsible inserts and showing a simplified schematic representation of a sealing device positioned over the fill fittings of the inserts to apply removable seals to the inserts.

FIG. 13 is a simplified, schematic representation of two groups of filled, sealed collapsible inserts secured to two separate holding trays with one holding tray stacked upon the fill fittings of the other group of inserts.

FIG. 14A is a sectional, perspective view of a prior art thick-liquid dispensing container showing a thick liquid remaining within the container and unable to be removed.

FIG. 14B is a simplified perspective drawing showing an expanded and filled collapsible insert secured upon an elevator platform within an interior void of a semi-rigid outer shell.

FIG. 14C is a simplified perspective drawing of the FIG. 14B collapsible insert, showing the insert partially collapsed after dispensing thick-liquid contents within the insert.

FIG. 14D is a simplified perspective drawing of the FIG. 14B collapsible insert, showing the elevator platform adjacent a top end of the interior void of the semi-rigid outer shell after the thick liquid has been dispensed from the collapsed collapsible insert.

FIG. 15 is a schematic, perspective drawing showing two helical tracks defined upon an interior surface of a shell, and showing a portion of the helical tracks defining multiple revolutions of the helical track between a bottom end and a top end of the shell, and showing portions of the helical tracks defining about one half of a revolution about the perimeter of the shell between the top and bottom ends of the shell.

FIG. 16 is a perspective view of the FIG. 15 helical tracks defined upon an interior surface of a shell and showing an elevator platform adjacent a bottom end of the shell.

FIG. 17 is a schematic, perspective representation of a track follower showing the track follower positioned within an ascending helical track that intersects a descending helical track wherein the track follower defines a length greater than a width of the helical track to avoid the track follower entering the descending helical track.

FIG. 18 is a schematic, perspective view of the FIG. 16 helical tracks and elevator platform and showing platform pins extending from the elevator platform into the FIG. 17 track follower within the helical tracks.

FIG. 19 is a schematic, perspective view of a rigid shell defining helical tracks and an elevator platform having aligning posts passing through the platform to restrict rotation of the elevator platform relative to rotation of the rigid shell.

FIG. 20 is schematic, perspective view of the FIG. 19 semi-rigid outer shell and showing a collapsible insert within interior void of the shell and mounted upon an elevator platform.

FIG. 21 is a schematic, perspective view of the FIG. 19 rigid shell and showing a collapsible insert secured upon a compression layer to apply a constant upward pressure to the collapsible insert.

FIG. 22A is a schematic, perspective view of a dispensing top of a twistable refillable container showing an outer-cap as measuring cup.

FIG. 22B is a schematic, perspective view of a dispensing top of a twistable refillable container showing a reservoir secured to the dispensing top that is filled upon dispensing from the container, and then poured out of the reservoir.

FIG. 22C is a schematic, perspective view of a dispensing top of a twistable refillable container in the form of a spray nozzle.

FIG. 22D is a schematic, perspective view of a dispensing top of a twistable refillable container inverted to apply dispensed substances to a sponge or paint pad.

FIG. 23 is a simplified, perspective view of an exemplary semi-rigid outer shell including a trigger-shaped drive mechanism for actuating a ratchet mechanism to rotate a collapsible insert.

FIG. 24 is a simplified, perspective view of a refillable container and showing a discharge cap secured to a semi-rigid outer shell.

FIG. 25 is a simplified, perspective view of the FIG. 24 refillable container and showing the discharge cap removed to expose a collapsible insert within the semi-rigid outer shell.

FIG. 26 is a simplified, perspective view of the FIG. 24 discharge cap.

FIG. 27 is a bottom perspective view of the FIG. 26 discharge cap and showing exemplary gear mechanism that provides for rotation of the FIG. 25 collapsible insert upon rotation of a dispensing spout of the discharge cap.

FIG. 28 is a perspective view of a FIG. 23 refillable container and showing an alternative discharge cap and measuring cup.

FIG. 29 is a simplified, side plan view of a refillable container including a trigger drive mechanism and measuring cup secured to the container.

FIG. 30 is a simplified, side plan view of the FIG. 29 refillable container and showing the container inverted so that a dispensed substance is poured into the measuring cup which is detachable from the container.

FIG. 31 shows the FIG. 30 refillable container returned to an upright position without the measuring cup.

FIG. 32 is a top plan view of a multistage sequence for securing a plurality of collapsible inserts to a bottom fixture and a top alignment plate.

FIG. 33 is a side plan view of the FIG. 32 multistage sequence.

FIG. 34 is a simplified perspective view of a side-force extraction embodiment of a refillable container of the present disclosure and showing the container in a dispensing mode.

FIG. 35 is a simplified perspective view of the FIG. 34 refillable container and showing the container in a refill mode.

FIG. 36 is a front perspective, fragmentary view of the FIG. 34 refillable container having a semi-rigid outer shell removed and showing a collapsible insert positioned between opposed compression plates secured to a helical axle.

FIG. 37 is a simplified, fragmentary perspective view of the FIG. 34 side-force extraction embodiment and showing two helical axles extending between two opposed geared rotation disks of the container.

FIG. 38 is a top perspective view of the Figure refillable container showing a collapsible insert secured between opposed compression plates and two helical axles.

FIG. 39 is a front perspective view of the FIG. 38 refillable container showing the compression plates completely compressing the collapsible insert.

FIG. 40 is a perspective view of an alternative side-force extraction embodiment showing a refillable container in a dispensing mode and showing a pump actuator drive mechanism on a front surface of a semi-rigid outer shell of the container.

FIG. 41 is front perspective view of the FIG. 40 refillable container showing the container in a refill mode.

FIG. 42 is fragmentary, front perspective view of the FIG. 40 refillable container having a front wall of a semi-rigid outer shell removed and showing a collapsible insert secured within the container between opposed compression plates and showing inflatable bladders secured between sides of the semi-rigid outer shell and the compression plates.

FIG. 43 is a fragmentary top perspective view of the FIG. 42 refillable container.

FIG. 44 is a fragmentary, front perspective view of the FIG. 42 refillable container and showing the compression plates completely compressing the collapsible insert and showing the air bladders completely expanded.

FIG. 45 is a simplified, plan view of a standard ratchet mechanism.

FIG. 46 is a perspective view of a collapsible insert having a through-hole handle and a fill fitment on the top and a spout fitment on the bottom of the collapsible insert according to one aspect of the present disclosure.

FIG. 47 is a perspective view of collapsible insert having an internal bladder and fluid input port according to one aspect of the present disclosure.

FIG. 48 is a perspective view of a collapsible insert support structure according to one aspect of the present disclosure.

FIG. 49 is a perspective view of a collapsible insert filling station in the open position according to one aspect of the present disclosure.

FIG. 50 is a perspective view of a collapsible insert filling station in the closed position according to one aspect of the present disclosure.

FIG. 51 is a block diagram of an online selection, ordering and collapsible insert filling and distribution system according to one aspect of the present disclosure.

FIG. 52A is a flow diagram of an online selection and ordering system according to one aspect of the present disclosure.

FIG. 52B is a flow diagram of a filling and distributions system according to one aspect of the present disclosure.

### DETAILED DESCRIPTION

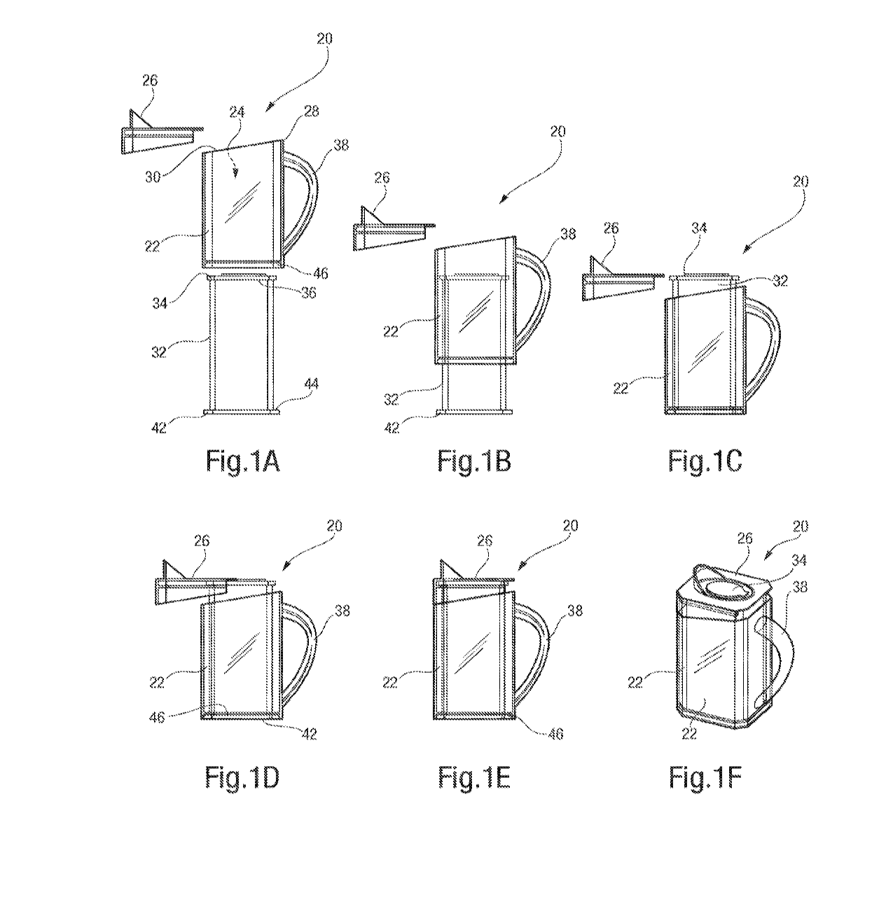

Referring to the drawings in detail, a simplified schematic drawing of a refillable container with a zero waste dispensing system is shown in simplified form in FIGS. 1A-1F and is generally designated by reference numeral 20. The refillable container 20 includes a semi-rigid outer shell 22 that defines an interior void 24. (For purposes herein, the phrase “semi-rigid” is to mean that the outer shell is sufficiently pliable to be squeezed, such as with a common, plastic ketchup or mustard container, and that the outer shell is not as rigid as a glass or steel shell would be.) The container 20 also includes a detachable pour spout 26 adjacent a top end 28 of the shell 22 and adjacent a top end 30 of the interior void 24. As shown in FIGS. 1A-1E, the pour spout 26 may be detachable from the semi-rigid outer shell 22.

A collapsible insert 32 is dimensioned to be selectively secured within the interior void 24 of the semi-rigid outer shell 22 and is also dimensioned to be selectively removed from the semi-rigid outer shell 22. The collapsible insert 32 and outer shell 22 are cooperatively formed to permit selective pouring of a flowable substance (not shown) through the pour spout 26 out of the shell 22. The collapsible insert 32 includes a securing coupler 34 affixed to a top end 36 of the insert and the coupler 34 is configured to mechanically engage the pour spout 26 of the semi-rigid outer shell 22. As shown in FIGS. 1A-1E, the securing coupler 34 may be dimensioned as a lip 34 extending beyond a perimeter of the collapsible insert 32 so that when the lip 34 extends out of the top end 28 of the shell 22, the pour spout 26 slides below the securing coupler 34 to thereby secure the insert 32 within void 24 of the outer shell 22. The semi-rigid outer shell 22 may also include a handle 38 for permitting a user (not shown) to lift and tilt the container 20. This embodiment 20 of the refillable container 20 may therefore be referred to for convenience as a tilt-pouring refillable container 20.

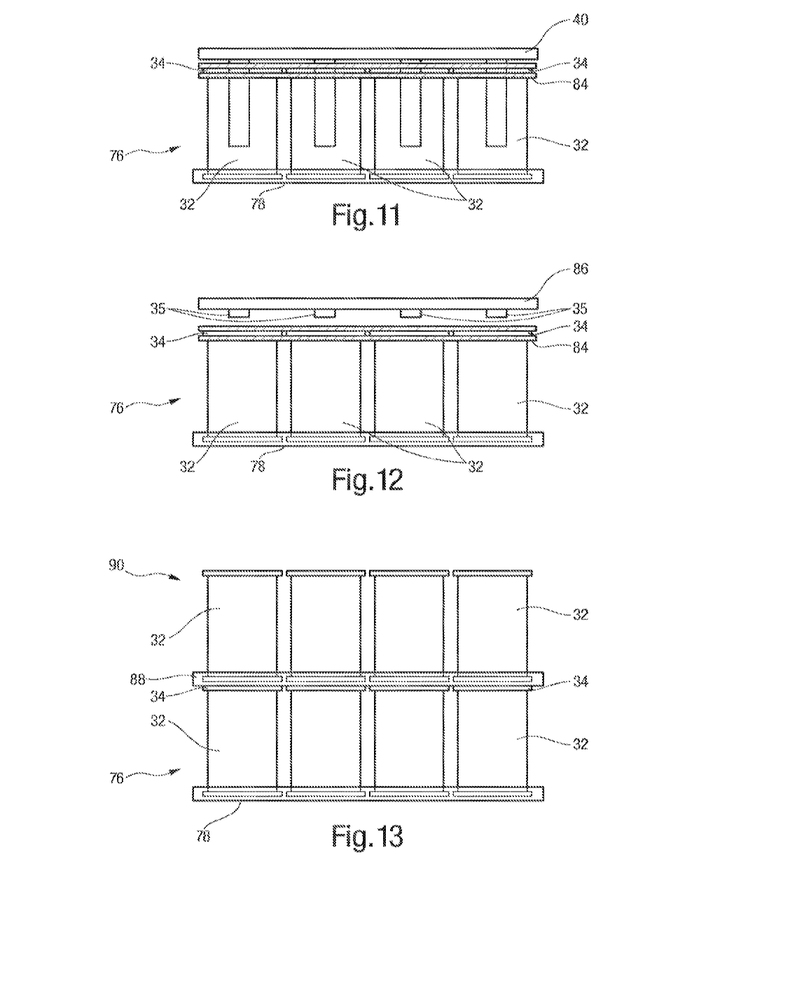

The securing coupler 34 also serves as a fill fitting 34 that is configured to mate with an automated filler 40, as shown schematically in FIGS. 10 and 11. As will be described in detail below mating of the fill fitting 34 with the automated filler 40 is accomplished before the collapsible insert 32 is positioned within the semi-rigid outer shell 22.

A base fixture 42 is secured to a bottom end 44 of the collapsible insert 32 opposed to the top end 36 of the insert 32. The base fixture 42 is constructed to engage and be selectively secured to a bottom end 46 of the semi-rigid outer shell 22. This prevents the collapsible insert 32 from collapsing or folding during pouring of a pourable substance (not shown) out of the insert 32 through the securing coupler 34 and pour spout 26 of the shell 22. By securing the base fixture 42 to the bottom end 46 of the shell 22, all of the pourable substance within the insert 32 is readily dispensed from the container 20, thereby providing for zero waste of the pourable substance.

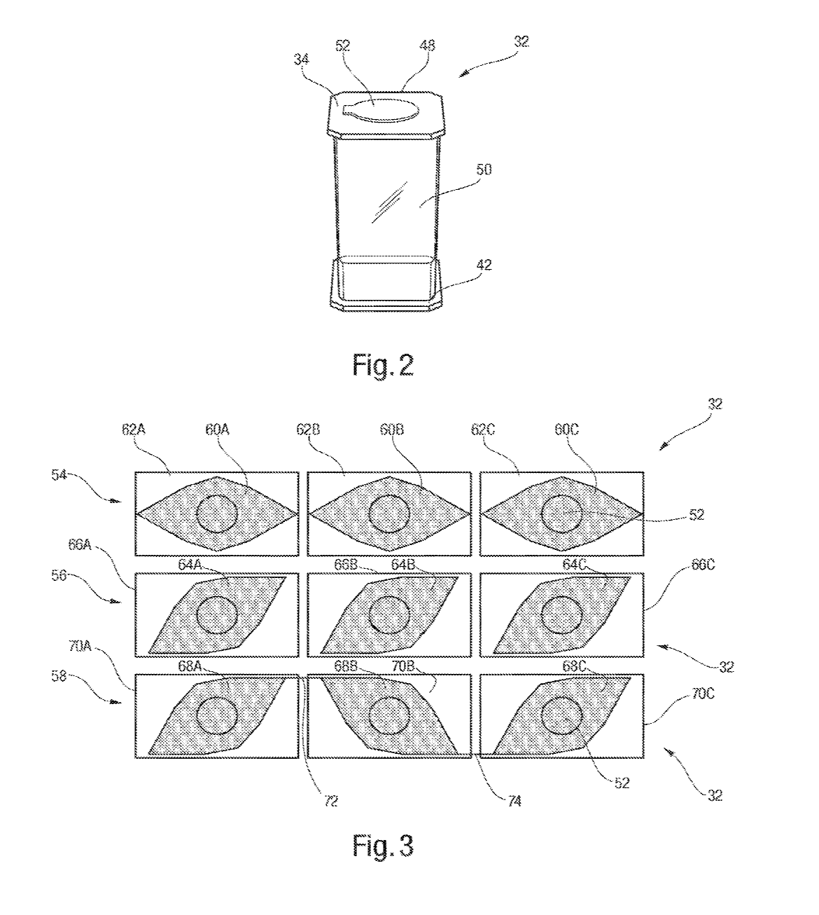

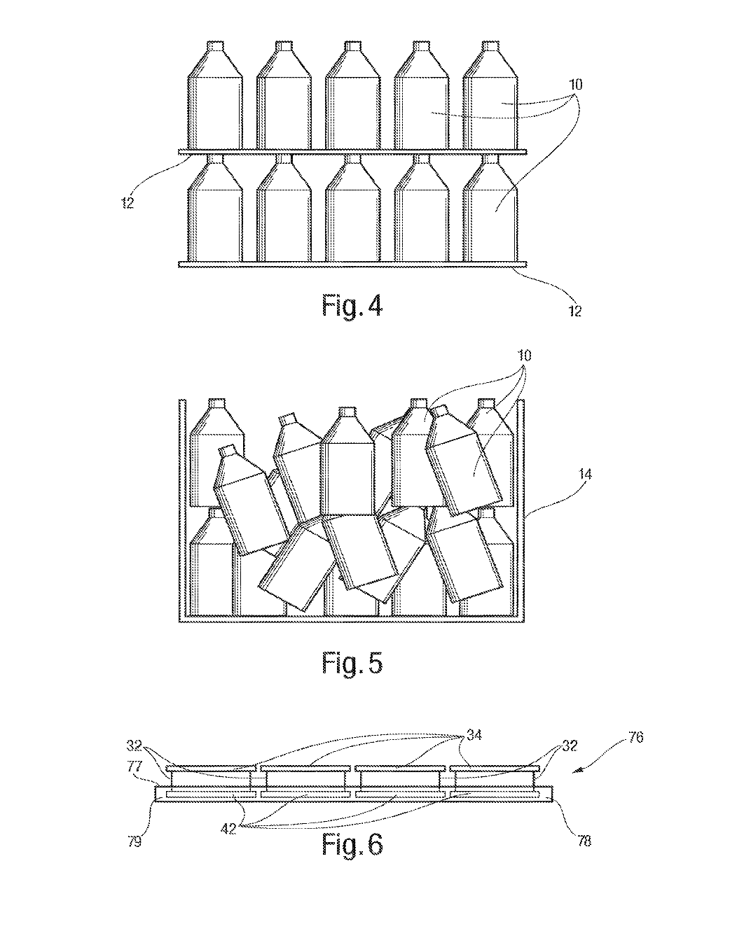

As is apparent from the sequence of FIGS. 1A-1F, an end user simply inserts the collapsible insert 32 into the interior void 24 of the semi-rigid outer shell 22, and then slides the detachable pour spout 26 onto the top end 28 of the shell 22 to engage the securing coupler 34 of the collapsible insert 32. The user may simply penetrate the securing coupler 34, or remove a seal tab (shown in FIG. 12) from the securing coupler 34 prior to or after insertion of the collapsible insert 32 into the shell 22. The base fixture 42 prohibits the insert 32 from collapsing into the void 24 of the shell, and the refillable container 20 is ready for use. After dispensing all of the contents of the insert 32, the pour spout 26 would be removed and another collapsible insert secured within the shell 22. It is to be understood, that while the pour spout 26 is shown in the FIG. 1A-1F embodiment as detachable, the disclosure includes a pour spout 26 that is not detachable from the outer shell, and simply secures the securing coupler 34 of the insert 32 in another manner that is known for securing a pour opening to a replaceable pourable substance container. FIG. 2 shows a collapsible insert 32 separated from the semi-rigid outer shell 22, and shows the securing coupler having a perimeter edge 48 that extends beyond a flexible body 50 of the insert 32. The securing coupler is also always in the form of a fill fitting 36 wherein a fill opening 52 is configured to both receive an automated filler 40, as seen in FIGS. 10 and 11, and to also engage the pour spout 26 of the semi-rigid outer shell 22.

As described above, the present disclosure includes manufacture of collapsible inserts 32 so that they may be transported from a place of manufacture (not shown) to a place of filling (not shown) in a collapsed state. Manufacture of the flexible bodies 50, securing couplers 34 and base fixtures 42 of the collapsible inserts 32 may be most efficiently achieved by manufacturing the inserts 32 in groups of strips of inserts 32. FIG. 3 shows three optional sequential arrangement 54, 56, 58 of three groups of three collapsible inserts 32, wherein the inserts 32 are in the form of expandable pouches. In the first arrangement 54, pouch inserts 60A, 60B, 60C are arranged parallel to a long axis of a securing coupler 62A, 62B, 62C. In the second optional arrangement 56, pouch inserts 64A, 64B, 64C are arranged in parallel-diagonal arrangement relative to their three securing couplers 66A, 66B, and 66C. In the third optional arrangement 58, pouch inserts 68A, 68B, 68C are arranged in zig-zag arrangement relative to their three securing couplers 66A, 66B, and 66C. In this zig-zag arrangement 58, the pouch inserts 68A, 68B, 68C may be secured to each other at adjacent longitudinal seams 72, 74 for a longer duration during transport and filling operations. This provides for enhanced efficiencies in manufacture because such expandable, liquid-containing pouches are typically manufactured in a side-by-side arrangement secured to each other along adjacent longitudinal seams.

FIG. 6 shows that collapsible inserts 32 may be manufactured in strips with a predetermined number of inserts 32 secured to each other in a side-by-side arrangement. The inserts 32 may be manufactured so that base fixtures 42 of the collapsible inserts 32 are also joined together side-by-side to form a packet 76 of three or more collapsible inserts 32. The inserts 32 shown in FIG. 6 are shown in a collapsed state and secured in a side-by-side arrangement to a top surface 77 of a holding tray 78. As described above, such a side-by-side, or “six-pack” type of grouping of the inserts will facilitate processing of the collapsible inserts 32 through automated machinery utilized in transporting, separating and filling the inserts, as well as in adding structural integrity for retail display. While FIG. 6 shows the collapsed inserts 32 secured as group by the holding tray 78, alternative embodiments include the inserts being secured as groups by tear-separable base fixtures 42 or securing couplings 34.

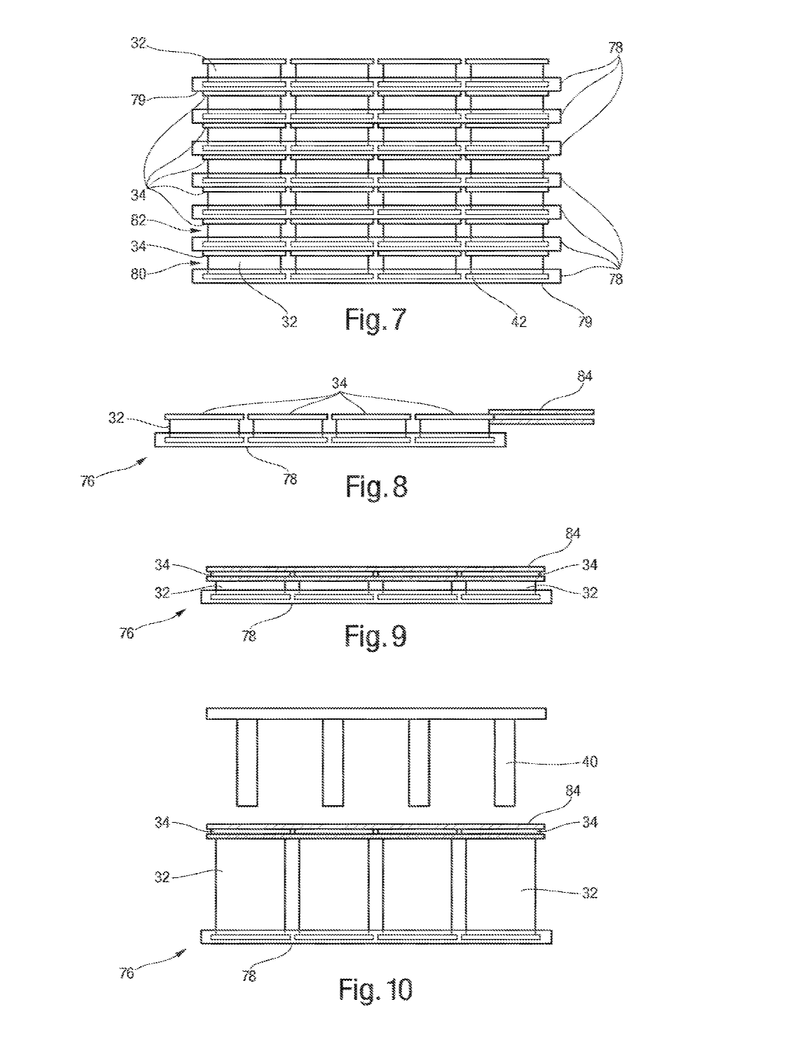

The holding trays 78 may be utilized to facilitate processing of the collapsible inserts 32 from manufacture, through filling of the inserts 32 to retail display and ultimately to acquisition by an end user (not shown). As shown in FIG. 7, the holding trays 78 may also include structures on opposed bottom surfaces 79 of the trays 78 to secure both the base fixtures 42 of a first set 80 of collapsible inserts 32 and the securing couplers 34 of a second set 82 of collapsible inserts 32, so that trays 78 of collapsible inserts 32 may be stacked upon each other. Such stacking of layers 80, 82 of collapsible inserts 32 may be utilized when the inserts 32 are empty and collapsed, or filled and expanded.

FIG. 8 shows a simplified, schematic representation of the plurality of collapsible inserts 32 shown in FIG. 6, wherein a lift device 84 is commencing engagement of fill fittings 34 of the packet 76 or plurality of inserts 76. FIG. 9 shows the lift device 84 engaging all the fill fittings 34 or securing couplers 34 of the packet 76 of collapsible inserts 32 on their holding tray 78. FIG. 10 shows schematically that the lift device 84 has expanded the packet 76 of collapsible inserts 32 above their holding tray 78 and that the fill device 40 has been positioned over the fill fittings 34 of the packet 76 of inserts 32. FIG. 11 simply shows that the fill device 40 has penetrated fill openings 52 of the fill fittings 34 of the packet 76 of collapsible inserts 32 to fill the expanded inserts 32 with a pourable liquid.

FIG. 12 shows a further sequential operation in the automated transport and filling of the packet 76 of collapsible inserts 32 by positioning a seal applicator 86 over the filling openings 52 of the fill fittings 34 after removal of the automated filler 40. The seal applicator 86 applies a seal 35 to each of the expanded, filled collapsible inserts 32. FIG. 13 shows that the filled packet 76 of collapsible inserts 32 may then receive a second holding tray 88 applied to the fill fittings 34 of the packet 76 so that a second packet 90 of expanded, filled collapsible inserts 32 may rest upon the second holding tray 88 which is upon the first packet 76 of collapsible inserts 32. The second holding tray 88 is applied after removal of the lift device 84 from the first packet 76. The same holding trays 78, 88 may be utilized in enhancing the efficiencies of transporting the packets 76, 90 of collapsible inserts 32 from a manufacturing facility (not shown) to a filling facility (not shown) and then for transporting the filled inserts to a warehouse or a point of sale facility (not shown).

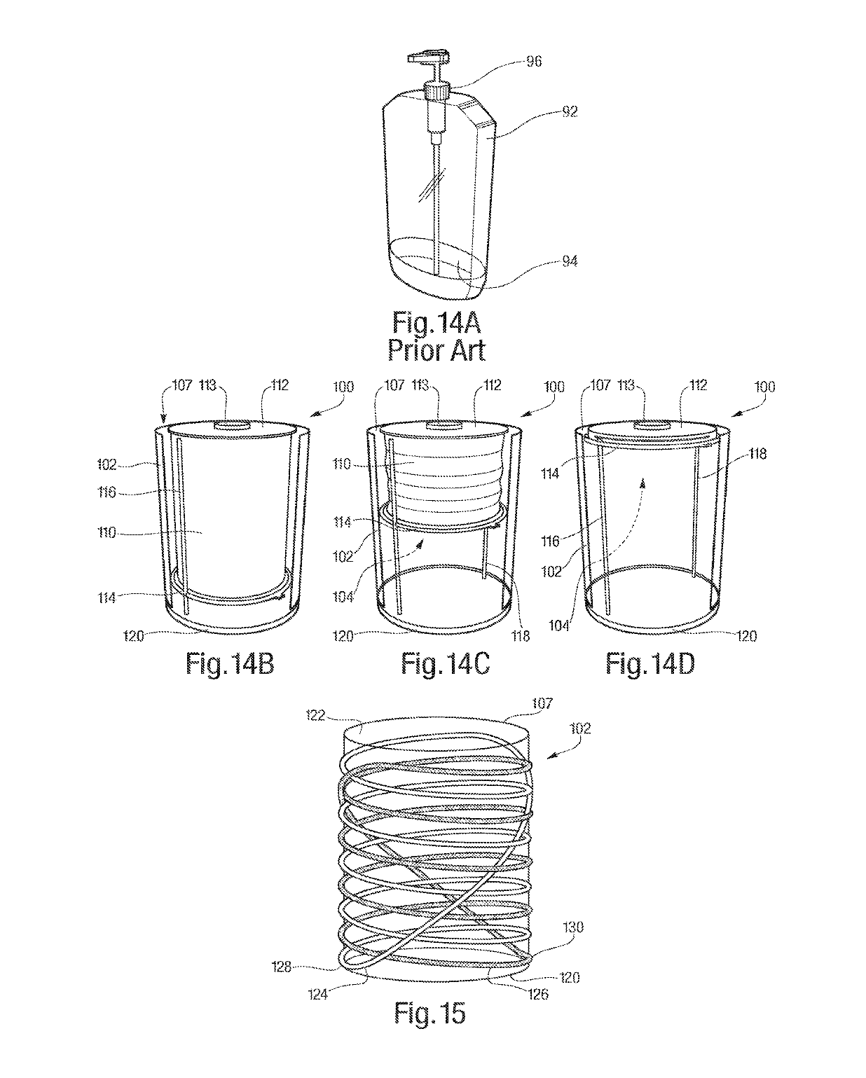

FIGS. 14B-14D and FIGS. 15-31 show further embodiments of the present disclosure of a refillable container with a zero waste dispensing system for non-pourable or slowly-pourable liquids, such as lotions, pastes, shampoos and other highly viscous substances. Such substances will be referred to herein for convenience as “thick liquids”. FIG. 14A shows a traditional prior art container 92 for a thick liquid for a lotion 94 that utilizes a plunger pump 96 to extract the thick liquid 94 or hand lotion. The sectional view of the prior art lotion container 92 shows much thick liquid 94 adhering to interior sides of the container 92 after the plunger pump 96 can no longer extract the thick liquid 94. This traditional dispensing system 92 for dispensing thick liquids 94 therefore leaves a lot of unused, wasted product.

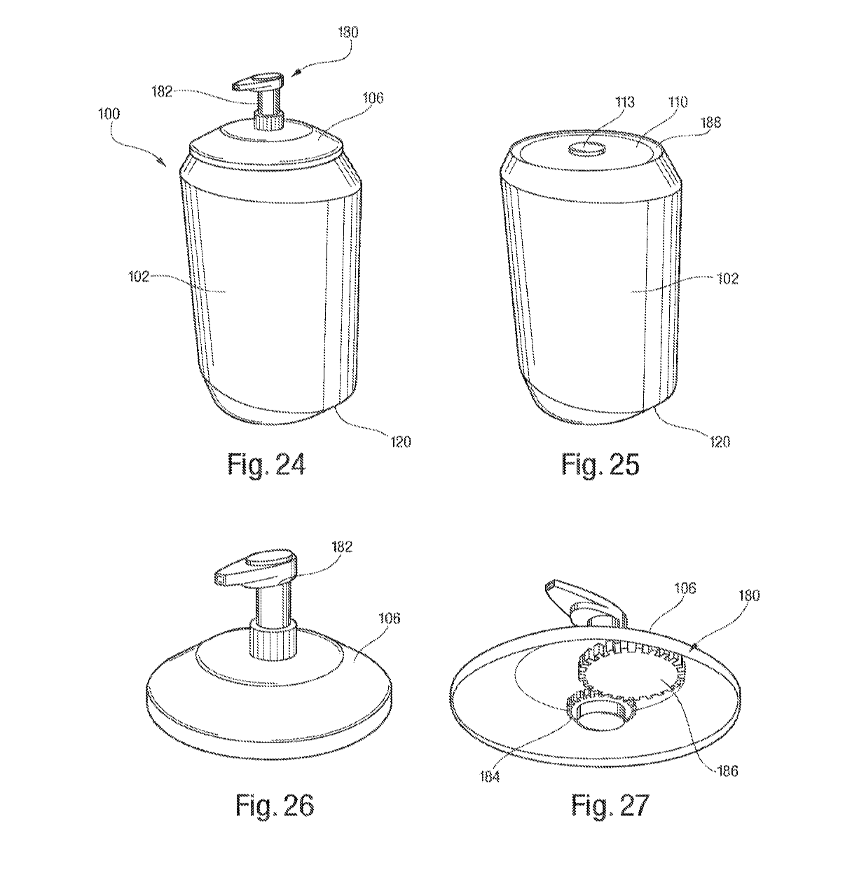

The sequence of drawings in FIGS. 14B, 14C and 14D show a thick liquid embodiment 100 of a refillable container with a zero waste dispensing system. This thick-liquid embodiment 100 also includes a semi-rigid outer shell 102 defining an interior void 104 and a discharge cap 106 (shown only in FIGS. 24-27) adjacent a top end 107 of the shell 102. A collapsible insert 110 is also included and is dimensioned to be selectively inserted into and removed from the interior void 104 of the shell 102. The collapsible insert 110 includes a securing coupler 112 having a fill opening 113 that is configured to mate and mechanically engage with the detachable discharge cap 106 of the shell 102. In FIG. 14B the collapsible insert 110 is shown fully expanded and resting upon an elevator platform 114. FIG. 14C shows the collapsible insert 110 partially collapsed having moved up the interior void 104 upon the platform 114, and FIG. 14D shows the collapsible insert 110 fully collapsed so that only the elevator platform 114 is visible adjacent the securing coupler 112 of the container 110. FIGS. 14B, 14C and 14D also shows alignment posts 116, 118 that pass from a shell base 120 upward within the void 104 through the elevator platform 114 and into the discharge cap 106. The alignment posts 116, 118 may or may not be utilized to align the elevator platform 114 and control its rotation relative to the outer shell 102.

As described above, instead of relying upon the force of gravity to pour the contents out of the collapsible insert 110 upon tipping of the FIG. 1A container 20, the thick-liquid embodiment 100 utilizes varying efficient but complex extractions mechanisms to move the thick liquid within the insert 110 through the discharge cap 106 and out of the container 100.

A first extraction mechanism is shown generally in FIGS. 15-31. For convenience, this first extraction mechanism will be referred to herein as a helical track extraction mechanism. (As described above, for purposes herein, the phrase “helical track” is intended to include both a groove defined to descend below an inside surface 122 of the shell as well as a ridge defined to extend above the inside surface 122 of the shell. It is expected that most helical track extraction mechanism embodiments will be in the form a groove.)

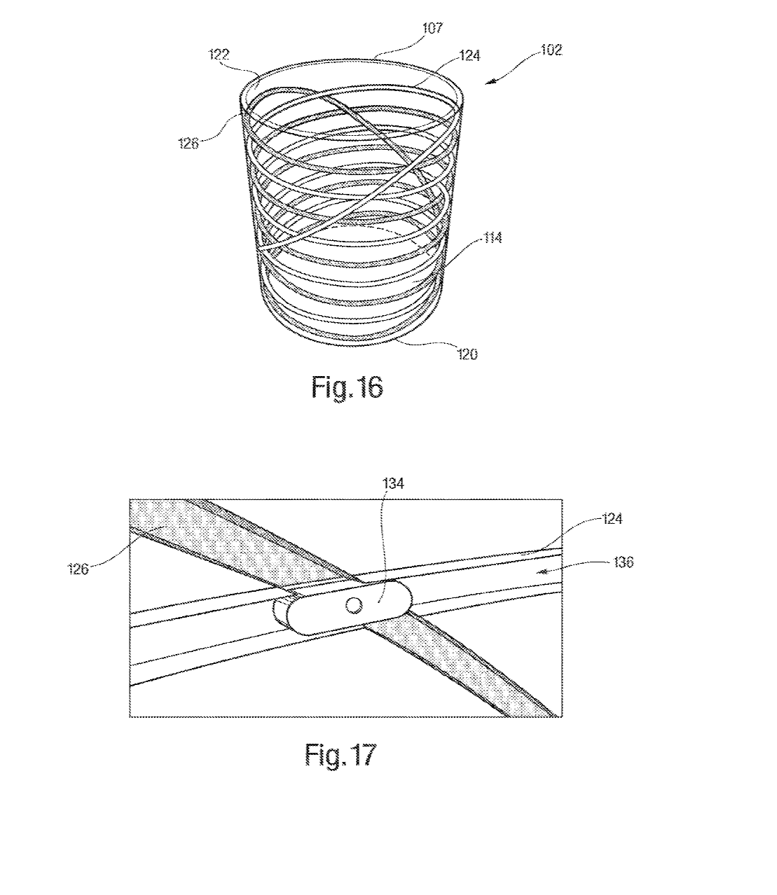

As shown in FIG. 15 a preferred embodiment includes a first helical track 124 and a second helical track 126 defined upon the inside surface 122 of the semi-rigid outer shell 102. The helical tracks 124, 126 may define endless loops that ascend from a first place of beginning 128 and a second place of beginning 130 of each track adjacent the shell base 120 of the rigid shell at a modest angle toward the top end 107 of the shell and then descend at a very acute angle back to the shell base 120 to the places of beginning 128, 130 of the helical tracks 124, 126. FIG. 16 shows a perspective view of the FIG. 15 helical tracks 124, 126 defined upon the interior surface 122 of the shell 102 and showing the elevator platform 114 adjacent the shell base 120.

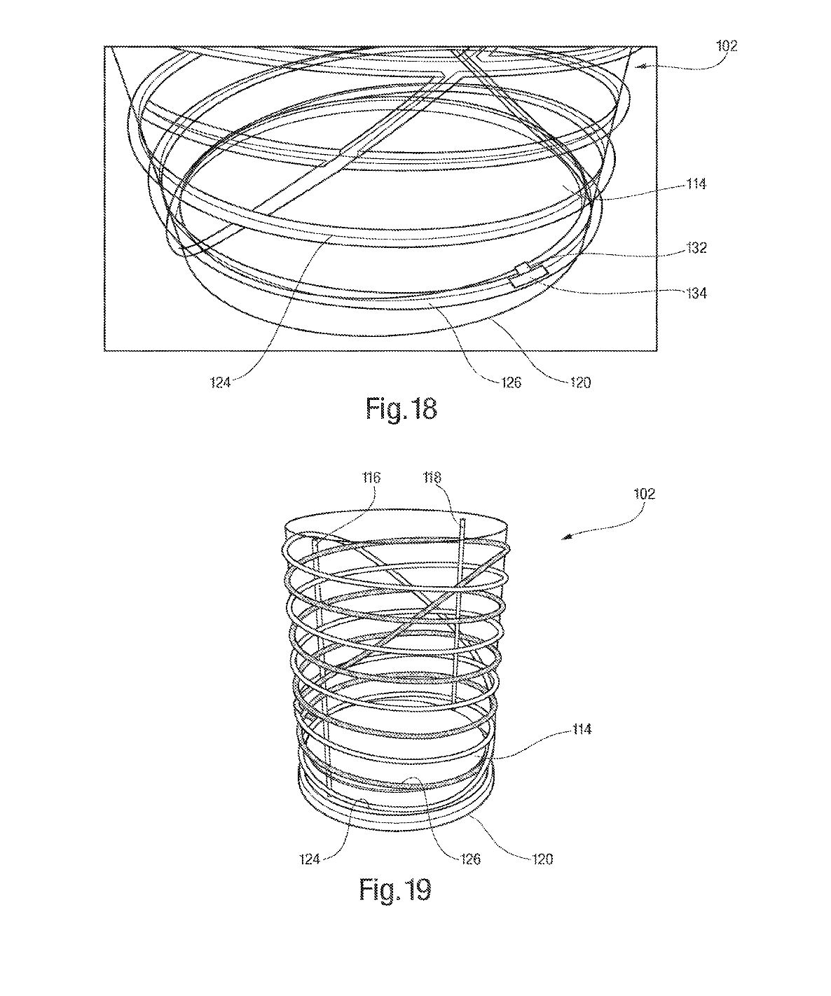

FIG. 18 shows the elevator platform 114 having a pin 132 extending away from a perimeter of the platform 114 into a track follower 134. The track follower 134 is configured to slide along the helical track 126, as within a groove as shown or upon a ridge (not shown). FIG. 17 shows the track follower 134 positioned within a groove 136 of the first helical track 124 at a point where the first helical track 124 crosses over the second helical track 126. Track follower 134 is configured to define an axial length greater than a width of the helical tracks 124, 126 to avoid the track follower 134 entering a crossed helical track 124, 126.

FIG. 19 shows the elevator platform 114 within the rigid shell 102 and including the two alignment posts 116, 118 passing from the shell base 120 through the elevator platform 114. The alignment posts 116, 118 optionally serve to restrict rotation of the elevator platform 114 relative to rotation of the rigid shell 102.

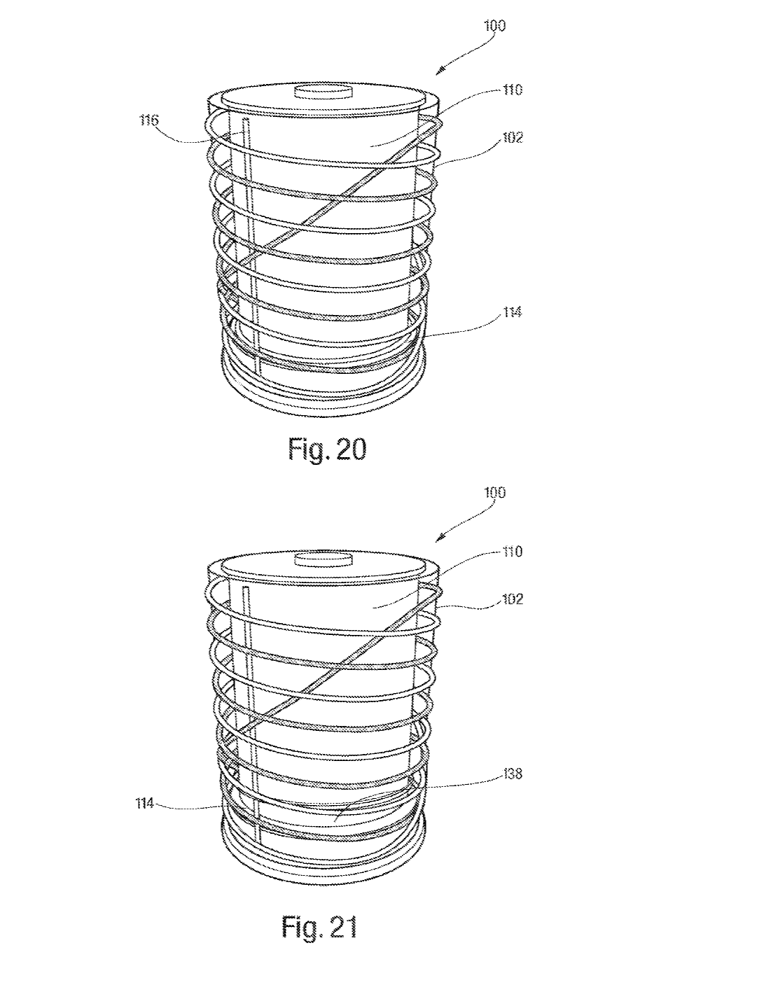

FIG. 20 shows the FIG. 14B collapsible insert 110 secured upon the elevator platform 114 within the semi-rigid outer shell 102. Use of the alignment posts 116, 118 permits the elevator platform 114 to rise as the outer shell 102 is rotated. This allows for the discharge cap 106 to remain stationary relative to the collapsible insert 110 while the outer shell 102 is rotated. FIG. 21 shows the FIG. 20 collapsible insert 110 secured upon a compression layer 138 that applies a constant upward pressure to the collapsible insert 110 to further minimize any loss or waste of contents within the insert 110 and to virtually eliminate ingress of any atmosphere or foreign material into the collapsible insert 110 through the discharge cap 106 during usage.

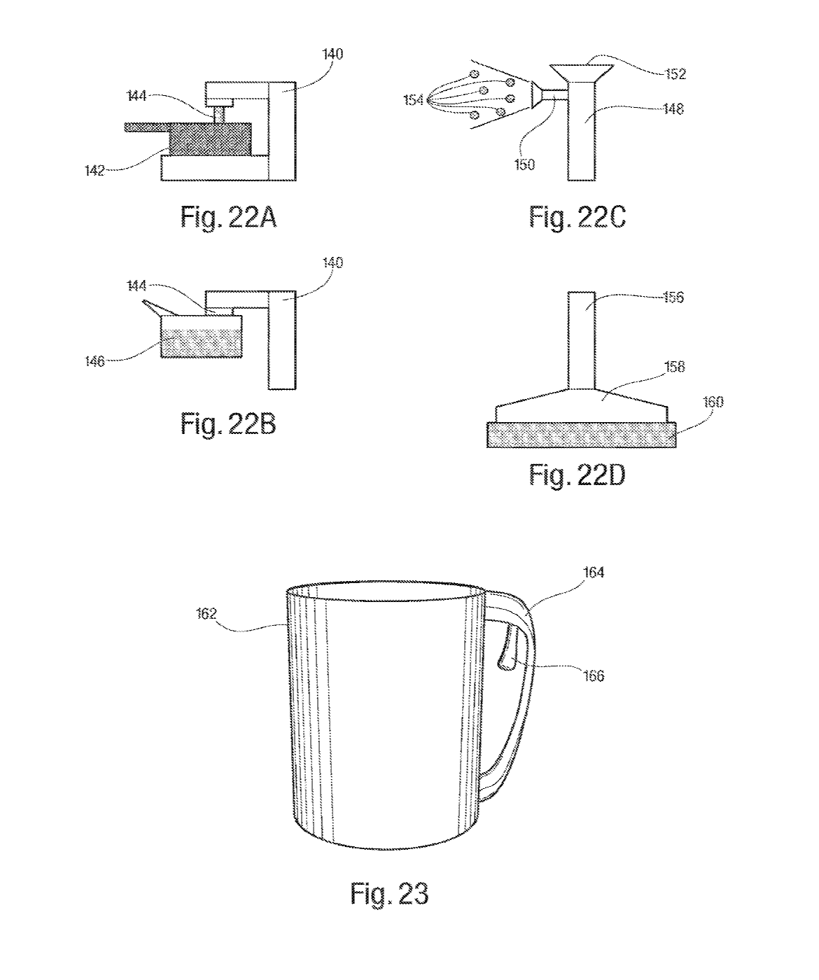

FIG. 22A shows a second discharge cap 140 of a helical track extraction embodiment of the refillable container 100. The second discharge cap 140 includes an outer-cap 142 as a measuring cup 142 that receives dispensed thick liquids by upward pressure of the elevator platform 114 through a pour nozzle 144. FIG. 22B shows the second discharge cap 140 utilizing the pour nozzle 144 to fill a reservoir 146 secured to the second discharge cap 140. The reservoir 146 is filled upon dispensing thick liquids from the container 100, and then poured out of the reservoir 146. This embodiment of the second discharge cap 140 provides for usage of the helical track embodiment of the container 100 with liquids that may be less viscous than pastes and hence slightly pourable, such as hair shampoos, conditioners etc.

FIG. 22C shows a third discharge cap 148 that includes a spray nozzle 150 and an on/off valve 152 that provides for spray of contents 154 of the container 100 upon twisting of the third discharge cap 148 to produce compression of the contents 154 within the collapsible insert 110.

FIG. 22D shows a forth discharge cap 156 that includes a wide-mouth outlet 158 that can be dimensioned to mate with or overlie a sponge 160 or other painting apparatus, to deliver a predetermined amount of a paint or other substance into the sponge 160 upon rotation of the discharge cap 156 or outer shell 102 of the container 100. Use of the forth discharge cap 156 would typically apply when inverting the container 100 to be upside-down during discharge.

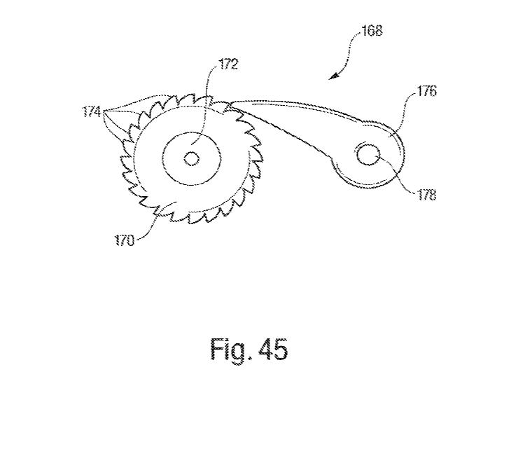

FIG. 23 shows an exemplary semi-rigid outer shell 162 including an integral handle 164 having a trigger-shaped drive mechanism 166 extending from the handle 164. The drive mechanism 166 is mechanically linked to a standard ratchet mechanism 168 that is shown in FIG. 45 in simplified form. The ratchet mechanism includes a ratchet wheel 170 secured to rotate about an axle 172, wherein the ratchet wheel 170 includes a plurality of angled teeth 174 surrounding the periphery of the ratchet wheel 170. A standard pawl 176 is configured to pivot on a pawl axle 178 that bears against the angled teeth 174 to permit only one-way movement of the angled teeth 174 under the pawl 176 upon rotation of the ratchet wheel 170 in a manner that is well known in the art. The ratchet mechanism 168 is secured within or adjacent a discharge cap 106, 140, 148, 156 to apply a one-way rotational force to gears that engage either the collapsible insert 110 or outer shell 102 to thereby move the elevator platform 114 to force the contents 154 within the insert 110 through a discharge cap 106, 140, 148, 156. Use of the ratchet mechanism 168 in the present disclosure prevents entry of air back into the container 100 and thereby enhances preservation of the quality of the contents of the refillable container 100.

FIGS. 24-27 show an exemplary usage of a drive mechanism 180 to rotate the first discharge cap 106 relative to a semi-rigid outer shell 102 of the thick-liquid, helical track refillable container 100. The first discharge cap 106 is secured to the outer shell 102 and includes a twist spout 182 that may be twisted to rotate a first gear 184 on the spout and below a top surface of the discharge cap 106. The first gear 184 rotates an adjacent second gear 186 that is configured to engage a gear receiving edge 188 of the outer shell 102. FIG. 25 shows the outer shell 102 and collapsible insert 110 without the discharge cap 106 exposing the gear receiving, or toothed edge 188 of the outer shell 102. Upon rotation by a user of either the twist spout 182 relative to the outer shell 102, or of the outer shell 102 relative to the twist spout 182, the track follower 134 commences movement up the helical track 124 to raise the elevator platform 114 upward toward the discharge cap 106 to thereby force contents 154 out of the insert 110 through the spout 182. FIG. 26 shows the first discharge cap 106 removed from the outer shell 102, while FIG. 27 shows a bottom view of the removed discharge cap 106.

Preferably the ratchet mechanism 168, or a practical variation thereof is secured within the discharge cap 106 to permit only one-way motion of outer shell 102 relative to the collapsible insert 110. Alternative embodiments include the helical tracks 124, 126 only ascending upward within the outer shell 102 and coming to a point of ending (not shown) adjacent the discharge cap 106, with a possible pawl release (not shown) to facilitate return of the elevator platform 114 to the shell base 120 by reverse rotation of the outer shell 102 relative to the twist spout 182. While the helical track embodiment 100 of the refillable container has described the manual rotation, geared and ratcheted embodiments above, it is to be understood that any other motive force known may also be utilized within the scope of the invention. For example, a small electric motor, battery and hand-actuated on-off switch (not shown) may be secured within the discharge cap 106 or other locations of the container 100 to achieve controlled, incremental relative rotation between the cap 106 and the outer shell 102 of the refillable container 100 to achieve discharge of predetermined amounts of the contents 154 of the container 100.

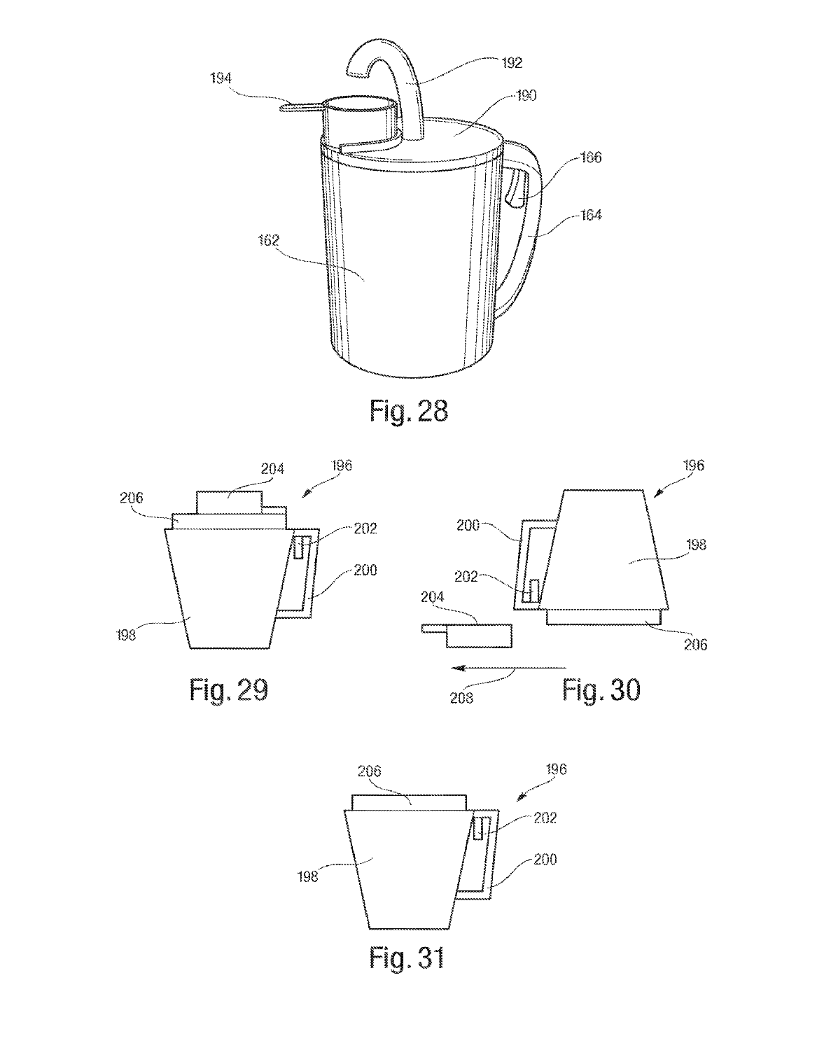

FIG. 28 shows the FIG. 23 refillable container 162 having the integral handle 166 and drive mechanism 164, but with a fifth discharge cap 190 having a curved spout 192 and integral measuring cup 194 for convenience in using the helical track container 100 for dispensing specific amounts of the contents 154. FIGS. 29-31 show use of an alternative helical track container 196 having an outer shell 198 and integral handle 200 with a drive mechanism 202 that is appropriate for dispensing flowable contents, such as ground coffee. A second measuring cup 204 is detachably secured to a sixth discharge cap 206. The container 196 of FIGS. 29-31 includes the same helical track extraction mechanism described above for helical track container 100. FIG. 30 shows that a user inverts the container 196; activates the drive mechanism 202, and a predetermined amount of the contents is dispensed into the measuring cup 204. The measuring cup is then slidably disengaged from the discharge cap 206 in the direction of arrow 208. The container 196 is then returned to an upright position as shown in FIG. 31 awaiting return of the measuring cup 204.

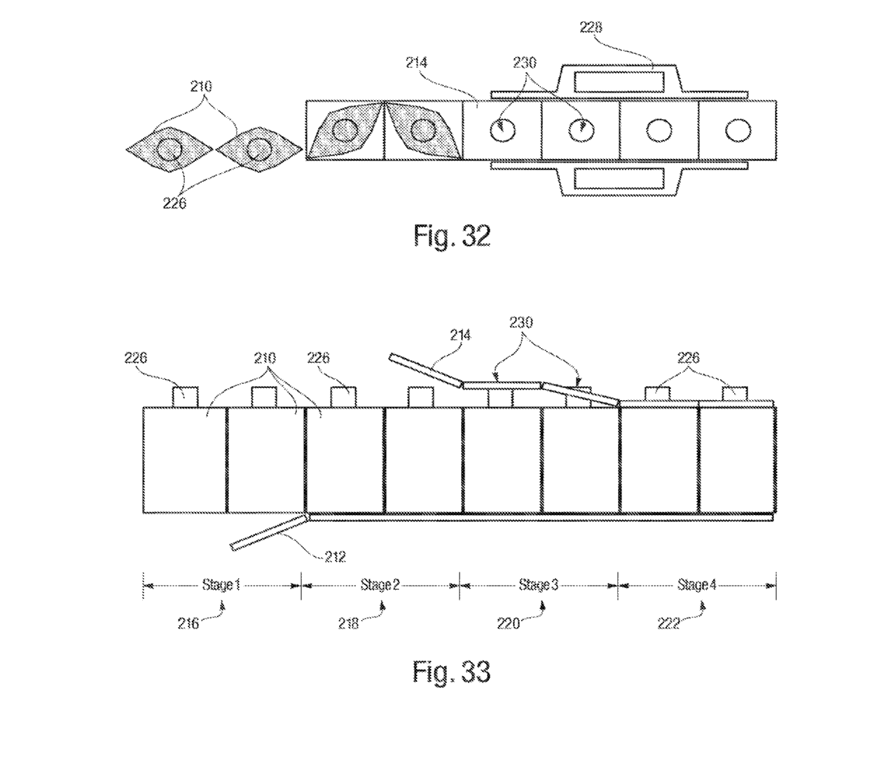

An efficient manufacturing process for manufacturing collapsible inserts is shown in FIGS. 32 and 33. FIG. 32 is a top plan view of a multistage sequence for securing a plurality of collapsible inserts 210 to a bottom fixture 212 and a top securing coupler 214. FIG. 33 is a side plan view of the FIG. 32 multistage sequence wherein a “Stage 1” is shown at reference numeral 216, “Stage 2” at 218, “Stage 3” at 220, and “Stage 4” is shown at reference numeral 222.

At Stage 1 in FIG. 32, 1 the pouch-like collapsible inserts 210 have been formed, inflated with air, and a fill fitment 226 has been attached. The inserts 210 are still empty throughout this Stage 1-Stage 4 manufacturing process. The inserts 210 are zigzagged in Stage 2 as shown in FIG. 33, and a roll of bottom fixture plate chip board 212 is attached with a hot melt glue (not shown). At Stage 3 the top securing coupler 214 chip board with handles 228 is applied while aligning fill openings 230 in the securing coupler roll 214 to the pouch fitments 226. In Stage 4 the securing coupler 214 is snapped over a locking feature (not shown) of the fill fitment 226. A continuous stream of 4-packs of the completed collapsible inserts 210 having secured bottom fixtures 212 and securing couplers 214 is then secured into holding trays 78, 87 for shipping. The collapsible inserts 210 are then compressed top to bottom while the air is released through the fill fitments 226 for compact shipment, as shown in FIGS. 6 and 7.

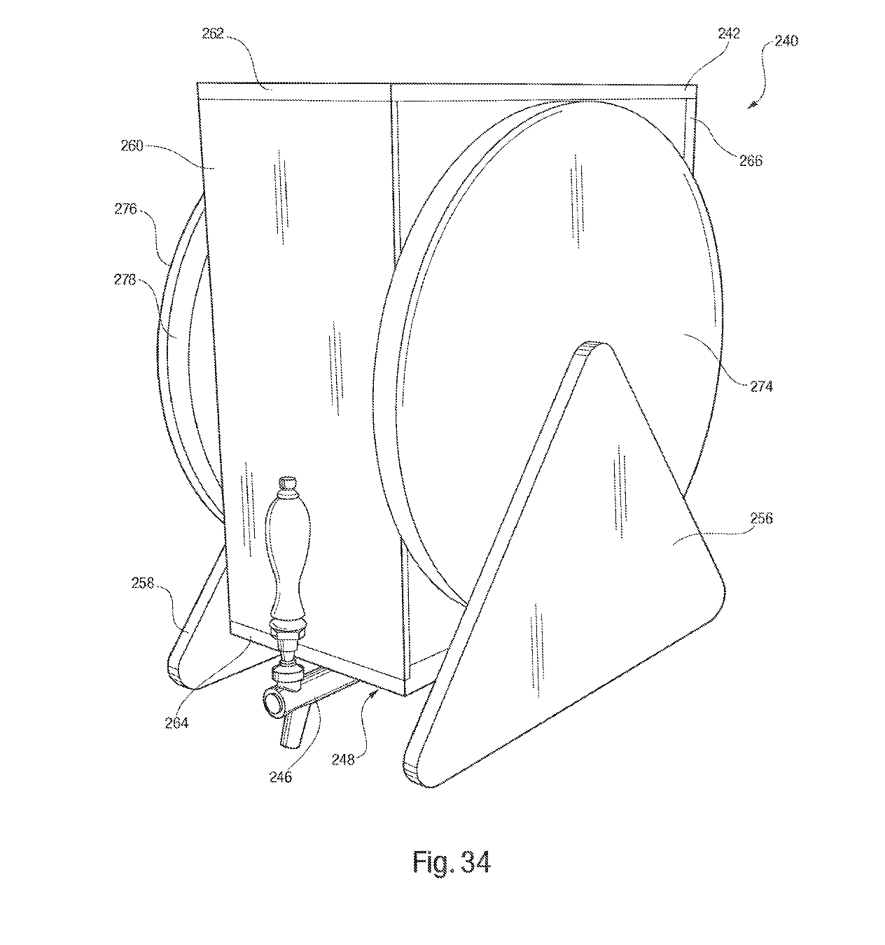

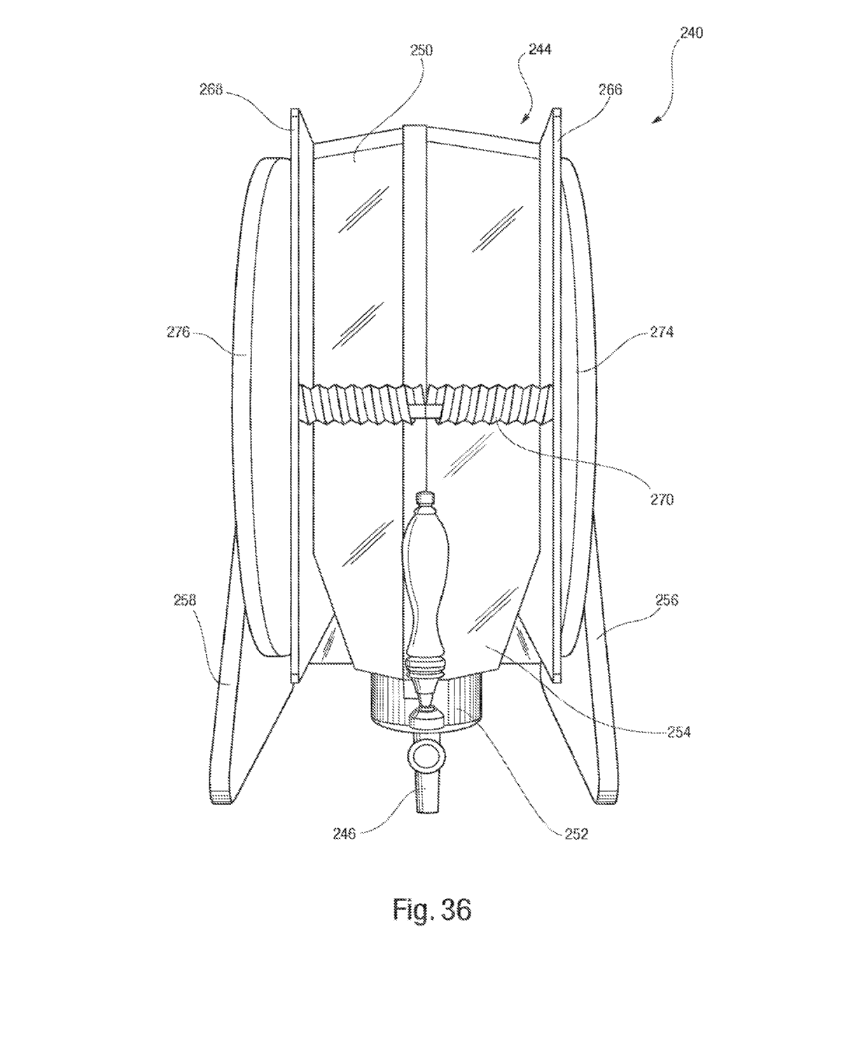

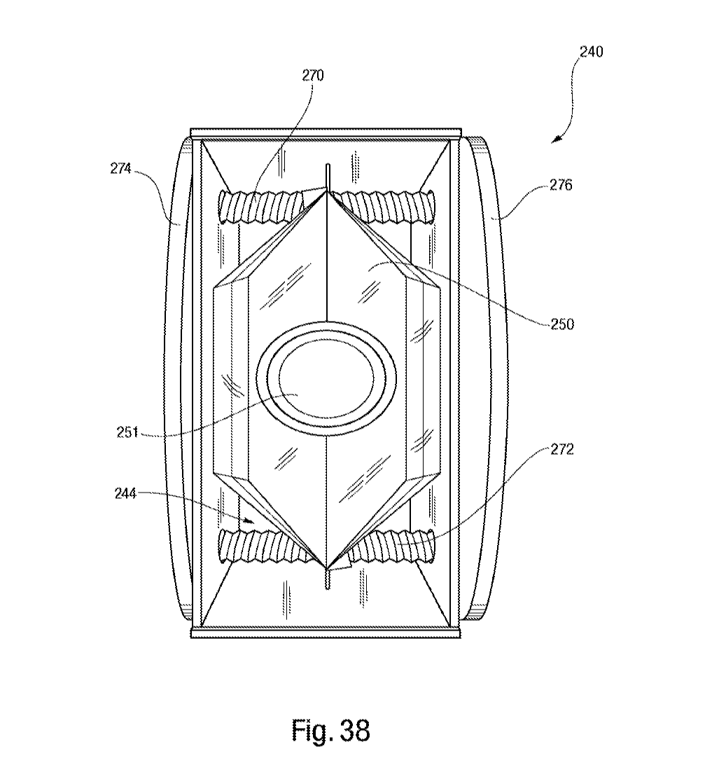

FIGS. 34-44 show additional embodiments of the refillable container that utilize an alternative extraction mechanism. This extraction mechanism involves applying force to one or more sides of a collapsible insert secured within a semi-rigid outer shell. FIGS. 34-39 show an exemplary alternative refillable container 240 referred to herein as a helical axle side-force extraction refillable container 240. The container 240 includes a semi-rigid outer shell 242 that defines an interior void 244 and includes a pour spout 246 adjacent a pour end 248 of the outer shell 242 and interior void 244. A collapsible insert 250 (shown in FIGS. 36, 38) is dimensioned to be selectively secured within the interior void 244 of the outer shell 242. The collapsible insert 250 includes a securing coupler 251 (shown in FIG. 38) dimensioned to be housed within a receiver 252 of the pour spout 246 of the outer shell 242. The securing coupler 251 is affixed to an insert pour end 254 of the insert and the coupler 251 is configured to be selectively secured to and detached from the pour spout 246. In an alternative embodiment, the pour spout 246 may be integral to the collapsible insert 250 and the pour spout 246 may protrude from the interior void 244 of the outer shell 242 to the exterior of the outer shell 242.

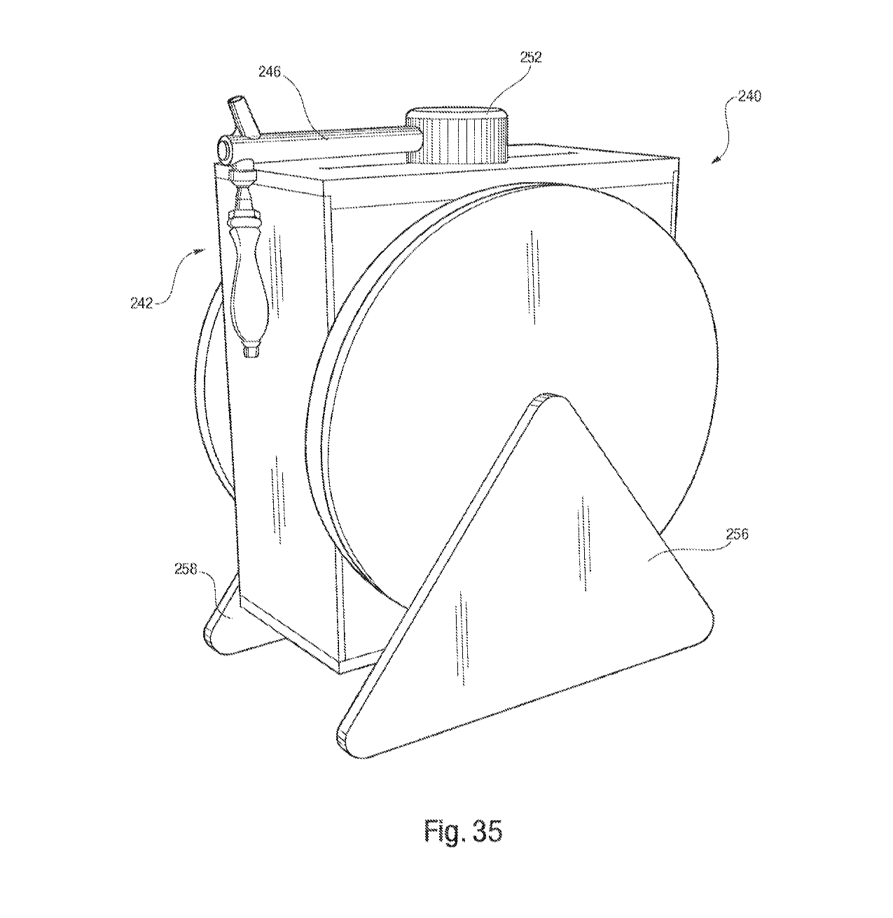

FIG. 34 shows that helical axle refillable container 242 may be pivotally mounted between a first pivot base 256 and a second pivot base 258. The semi-rigid outer shell 242 is pivotally secured between the pivot bases 256, 258 so the shell 242 may be deployed in a dispensing mode as shown in FIG. 34 or in a refill mode as shown in FIG. 35. The outer shell 242 also includes a front wall 260, top wall 262, a bottom wall 264, a first side wall 266 and a second side wall 268 (shown only in FIG. 36). In this helical axle embodiment 240, the side walls 266, 268 may be rigidly secured to the front, top and bottom walls 260, 262, 264 so that opposed compression plates may be secured within the shell 242.

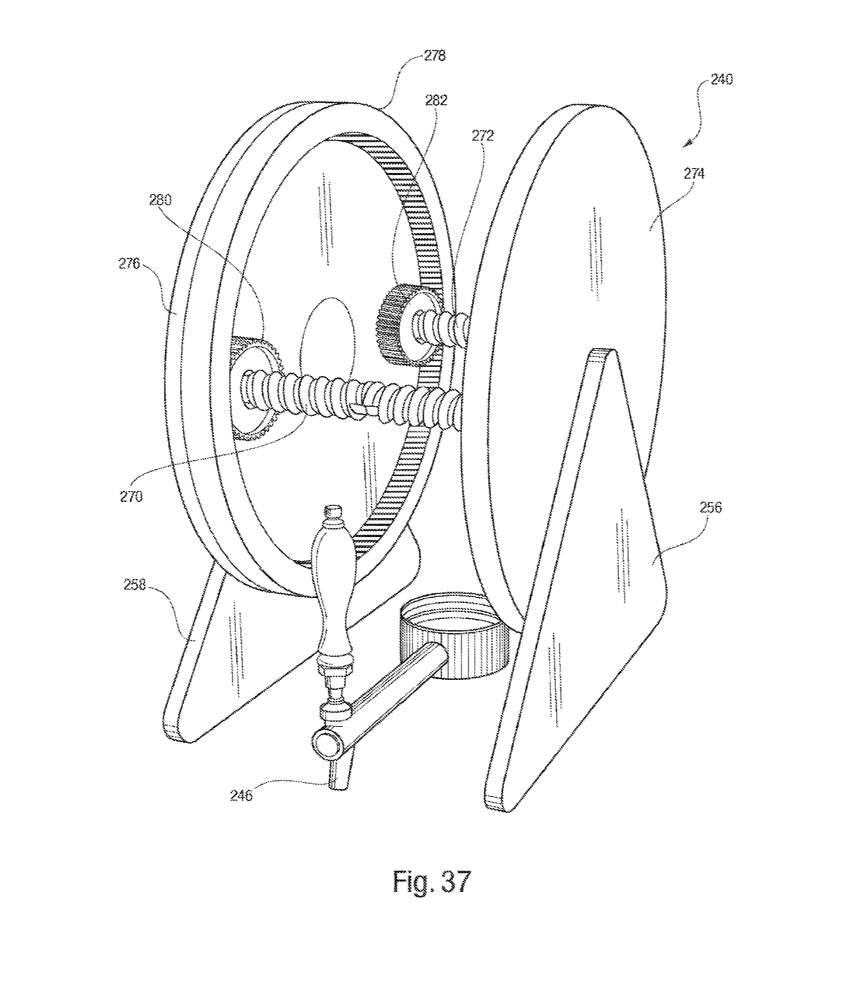

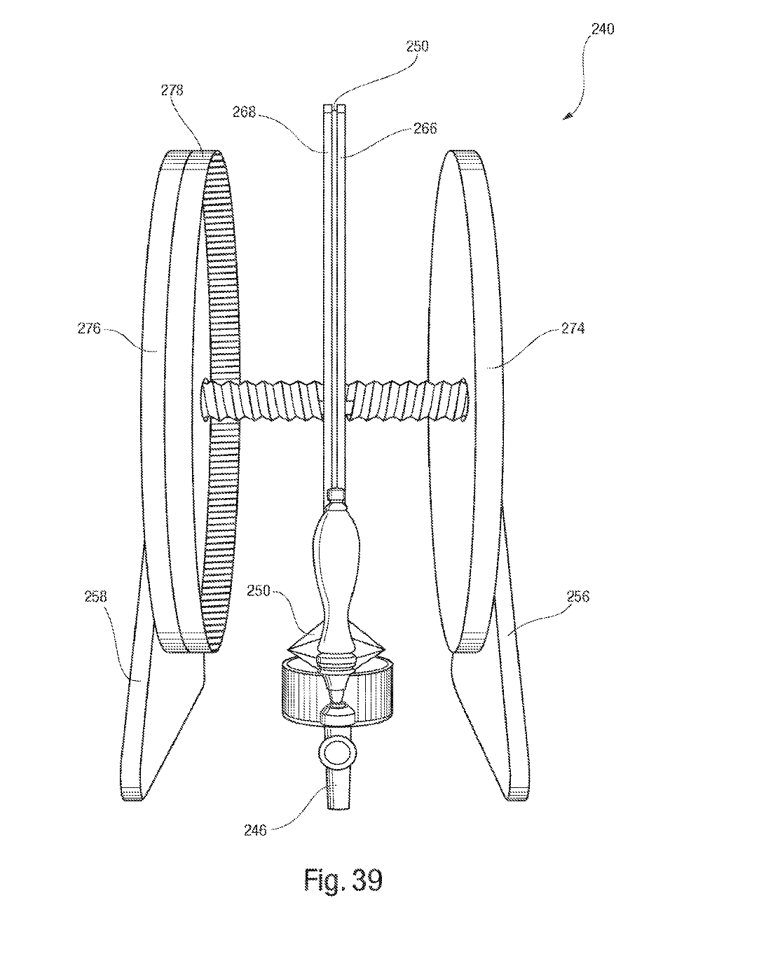

Alternatively, and as shown in FIGS. 34-36, and FIGS. 38, 39, the side walls 260, 262 may be slidably secured to the front, top and bottom walls 260, 262, 264 to thereby serve as compression plates 266, 268 to apply pressure to the collapsible insert 250. As shown best in FIGS. 36, 37, 38, 39 the helical axle container 240 may include a first helical axle 270 and preferably a second helical axle 272 that are secured through the opposed compression plates 266, 268 and are secured to a first support plate 274 and a second support plate 276 as shown in FIGS. 36, 39. As shown best in FIG. 37, one of the support plates 274, 276 includes a driver gear 278 adjacent a perimeter of, for example, a second support plate 276. The driver gear 278 engages a first axle gear 280 that also surrounds an end of the first helical axle 270, and the driver gear 278 also engages a second axle gear 282 that surrounds an end of a second helical axle 272.

Rotation by a user (not shown) of the support plates 274, 276 therefore causes rotation of the helical axles 270, 272 as shown in FIGS. 36 and 39, rotation of the helical axles 270, 272 causes the compression plates 266, 268 to remove from a fully expanded position shown in FIG. 36 to a fully compressed position shown in FIG. 39 which has completely collapsed an insert 250. While the mechanical rods extending between the first and second support plates 274, 276 are referred to herein as “helical axles”, and are described as moving the compression plates 266, 268 toward or away from each other upon rotation of the helical axles 270, 272, it is to be understood that the phrase “helical axles” is to include any known rods that can achieve the same function, such as threaded rods, notched rods using mechanical actuators or electro-mechanical actuators, etc.

In use of the helical axle container 240, the container 240 is pivoted about the pivot bases 256, 258 so that the pour spout 246 is upright, as shown in FIG. 35. As shown in FIG. 38, wherein the pour spout 246 and bottom wall 264 are removed, the collapsible insert 250 is placed within the interior void 244 between the first and second helical axles 270, 272. The bottom wall 264 is then repositioned and the receiver 252 of the pour spout 248 is secured in mechanical and fluid communication with the securing coupler 251 of the collapsible insert 250. The outer shell 242 is then repositioned from the refill mode (shown in FIGS. 35 and 38) to the dispensing mode (shown in FIGS. 34, 36, 37 and 39). A user (not shown) then rotates one of the support plates 274, 276 which in turn rotate the helical axles 270, 272 that forced the side walls or compression plates 266, 268 to apply a compressive force on the insert 250. Contents of the collapsible insert 250 may then pour out of the pour spout 246. Preferably, a ratchet mechanism 168 is secured in association with the driver gear 278, the first axle gear 280 or the second axle gear 282 to restrict reverse motion of the driver gear 278, to thereby restrict entry of air or other contaminants into the container 240. In an alternative embodiment, the collapsible insert 250 with an integral spout 246 may be selectively inserted and removed from the interior void 244 between the compression plates 266 and 268. Any combination of the side walls 260, 262, the front, top and bottom walls 260, 262 and 264 may be removed to allow for the collapsible insert 250 to be selectively inserted and removed from the interior void 244.

It is anticipated that this helical axle embodiment 240 may be utilized to minimize waste in transportation and distribution of common beverages such as beer, soda, fruit juices, etc. By utilizing the refillable outer shell 242 with non or slightly pressurized contents within the collapsible insert 250, enormous savings in both cost and volume and mass of liquid containers may be achieved. Additionally, the helical axle embodiment of the refillable container 240 may be utilized to dispense the same thick liquids described with respect to the helical track embodiment 100 of the refillable container of the present disclosure.

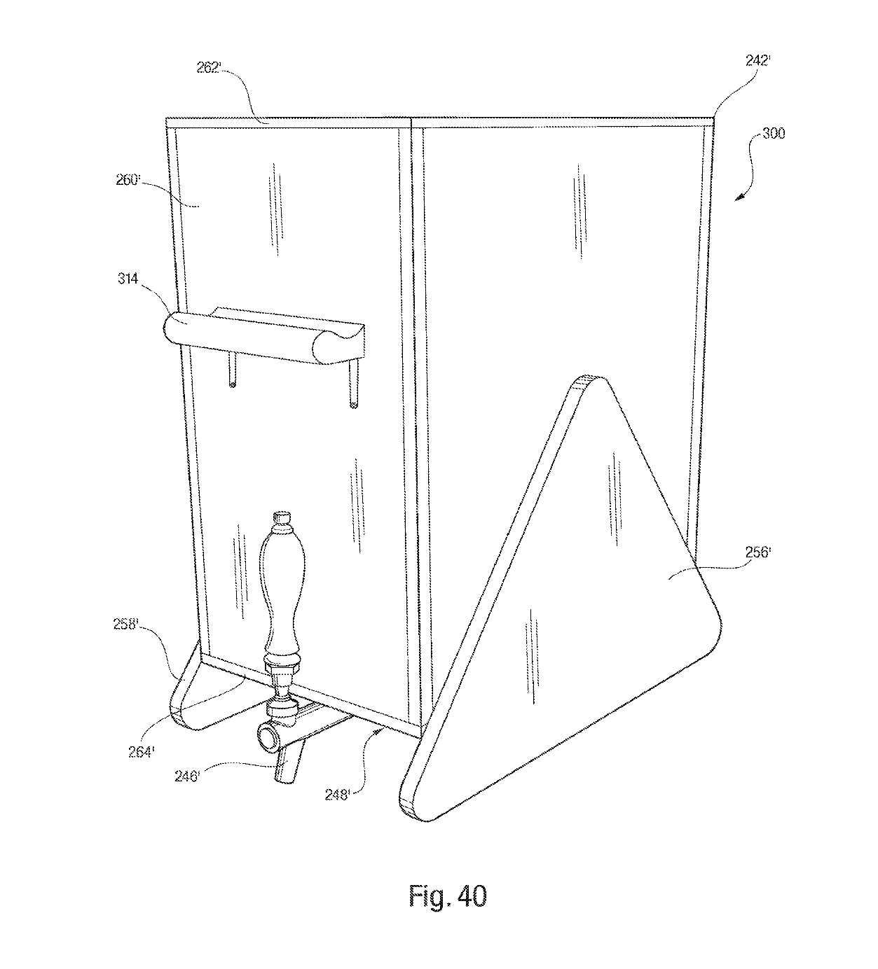

FIGS. 40-44 show an alternative extraction mechanism for an air-bladder refillable container 300. The air-bladder container 300 includes many virtually identical components described above with respect to the helical axle container 240 and those similar components will be identified in FIGS. 40-44 as primes of the reference numerals associated with the helical axle container 240. For example, the helical axle container 240 includes a semi-rigid outer shell 242 and in FIGS. 40-44 a semi-rigid outer shell is designated by reference numeral 242′. Other features of the air-bladder container 300 will simply be numbered in FIGS. 40-44 rather than providing a redundant description of those features.

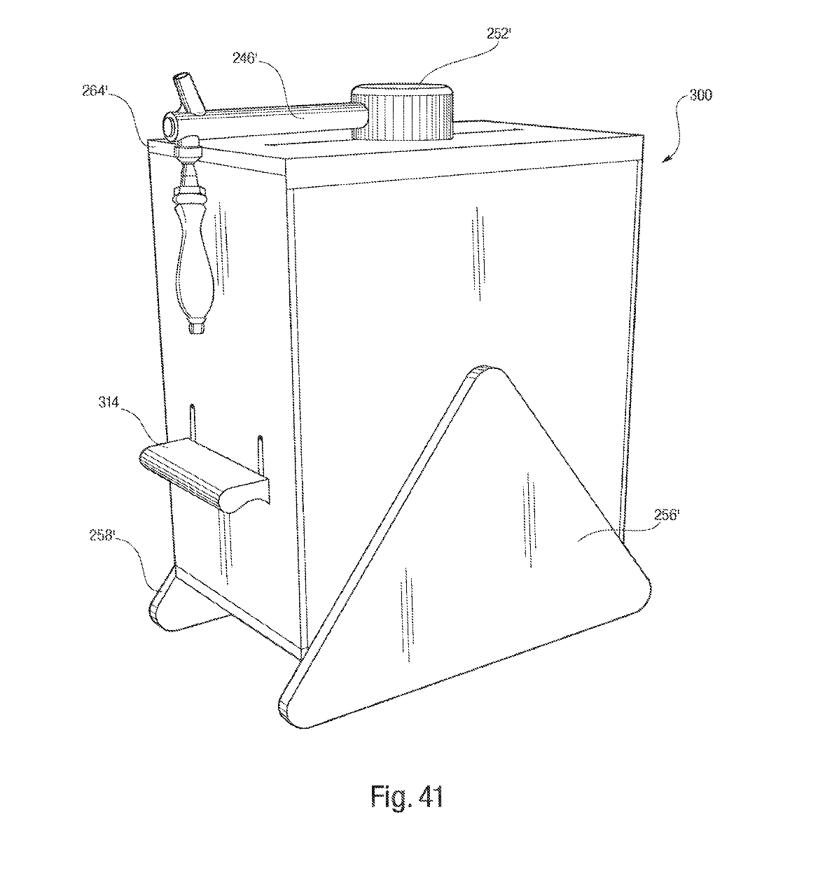

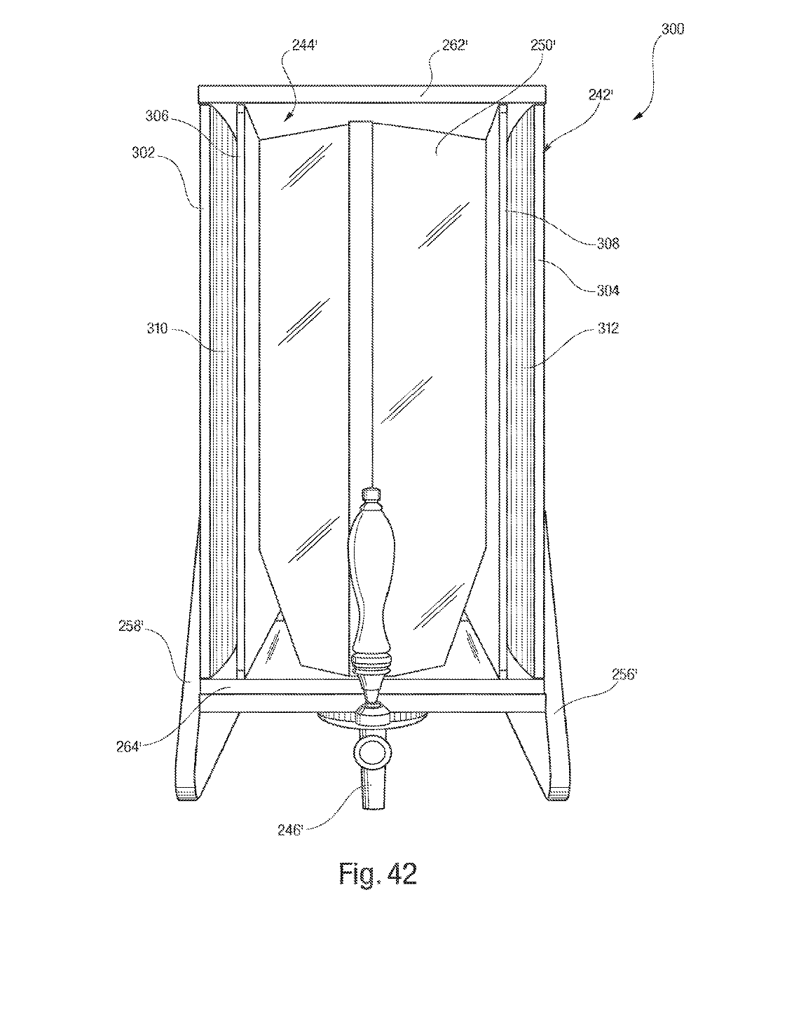

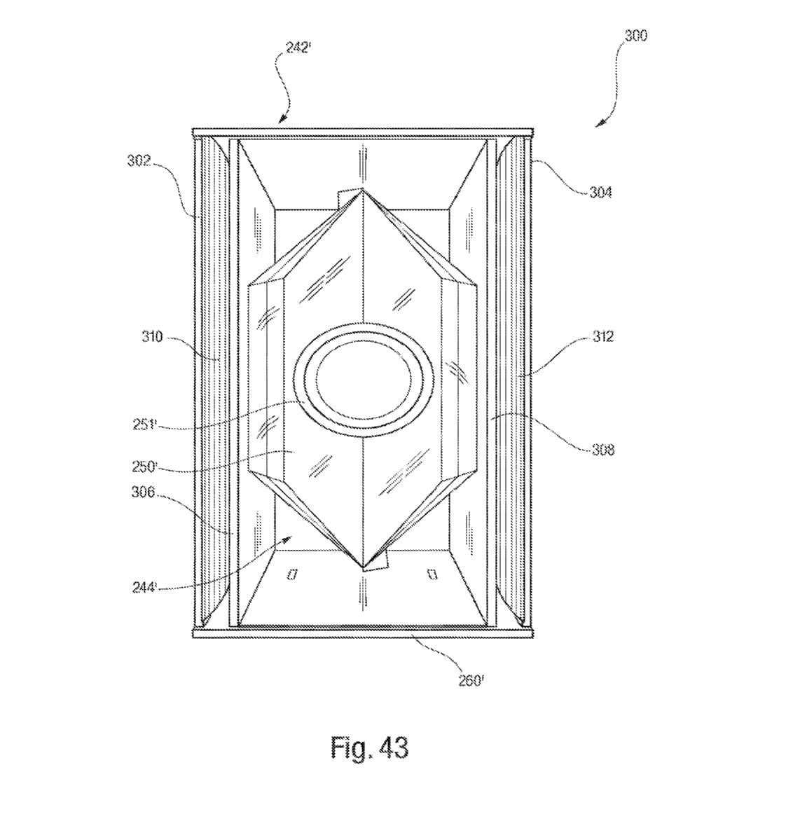

As shown best in FIG. 42 the air-bladder container 300 includes an outer shell 242′ that includes a first side wall 302 and a second side wall 304. In an alternative embodiment, the air bladder container 300 may be circular or any other shape suitable for housing the collapsible insert 250. These side walls 302, 304 are secured to the bottom wall 264′ and top wall 262′ and do not move relative to those walls 264′ and 262′. Within the interior void 244′ of the air-bladder container 300, a first compression plate 306 and a second compression plate 308 are secured in parallel alignment between the top wall 262′ and the bottom wall 264′. A first air-bladder 310 is secured between the first side wall 302 and the first compression plate 306 and a second air-bladder 312 is secured between the second side wall 304 and the second compression plate 308. In an alternative embodiment, the first air bladder 310 may be secured between the first side wall 302 and a first side of the collapsible insert 250 and the second air bladder 312 may be secured between the second side wall 304 and a second side of the collapsible insert 250. In yet another alternative embodiment, bladder container 300 may have only a first air bladder 310 or a second air bladder 312, such that a single bladder (310 or 312) may be compressing the first side of the collapsible insert and second side of the collapsible insert 250 may be in direct contact with the side wall (302 or 304). As shown in FIG. 40 a pump actuator 314 may be secured to the front wall 260′ of the outer shell 242′ to selectively compress a standard fluid pump (not shown) to pump fluid into the first and second air bladders 310, 312. In an alternative embodiment, the pump actuator 314 may be of any type and located on any surface of the bladder container 300. FIG. 41, like FIG. 35 for the helical axle container 240, shows the air-bladder container 300 in a refill mode. FIG. 43, like FIG. 38 for the helical axle container 240, shows the air-bladder container having a collapsible insert 250′ inserted within the interior void 244′ of the outer shell 242′ and between the compression plates 306, 308.

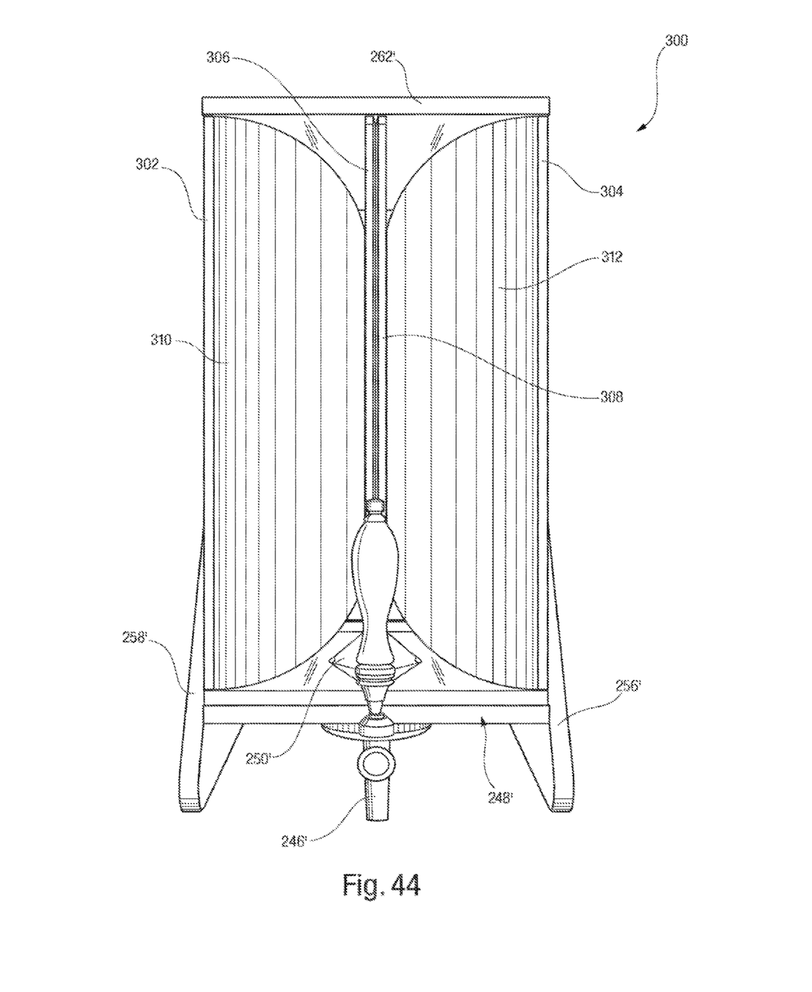

As best shown in FIG. 44, the compression plates 306, 308 may be compressed by incremental expansion of the air bladders 310, 312 to apply a compressive force to the insert 250′ to thereby expel contents of the insert 250′ out of pour spout 246′. Like the helical axle container 240, the air-bladder container 300 benefits from use of a plurality of collapsible inserts 250′ that can be utilized to refill the container 300 indefinitely. This again provides for enormous savings and manufacture and transport of the inserts 250′, and in reduction of an overall volume and mass of used product containers. The air-bladder container 300 also includes ordinary fluid pump control apparatus (not shown) known in the art to selectively apply incremental increases in fluid pressure within the air bladders 310, 312. Such fluid pump control apparatus may include a mechanical pump actuated by the pump actuator 314, electric powered pumps, hydraulic pumps, with known flow controllers that are capable of performing the functions described above. The pump control apparatus also includes an ordinary check valve (not shown) or other one-way valve to ensure that pressurized fluid does not flow back from the air bladders 310, 312 through the pump apparatus. In yet another alternative embodiment, the fluid pump (not shown) may be any type of electric powered fluid pump where the power source may be a rechargeable battery or any other suitable power type. The powered fluid pump may be controlled by any type of microprocessor controller (not shown) and configured to read a pressure within the collapsible insert 250, using any suitable pressure sensor (not shown). The pressure may be preset to a controlled pressure and the controller may turn the powered fluid pump on and off to maintain the preset controlled pressure. The actual pressure within the collapsible insert may be displayed on any suitable electronic display (not shown) located anywhere on the air bladder container 300. This also, like the ratchet mechanism 168 in the helical track 100 and helical axle 240 containers, prohibits entry of atmosphere or any other contaminants into the container 300.

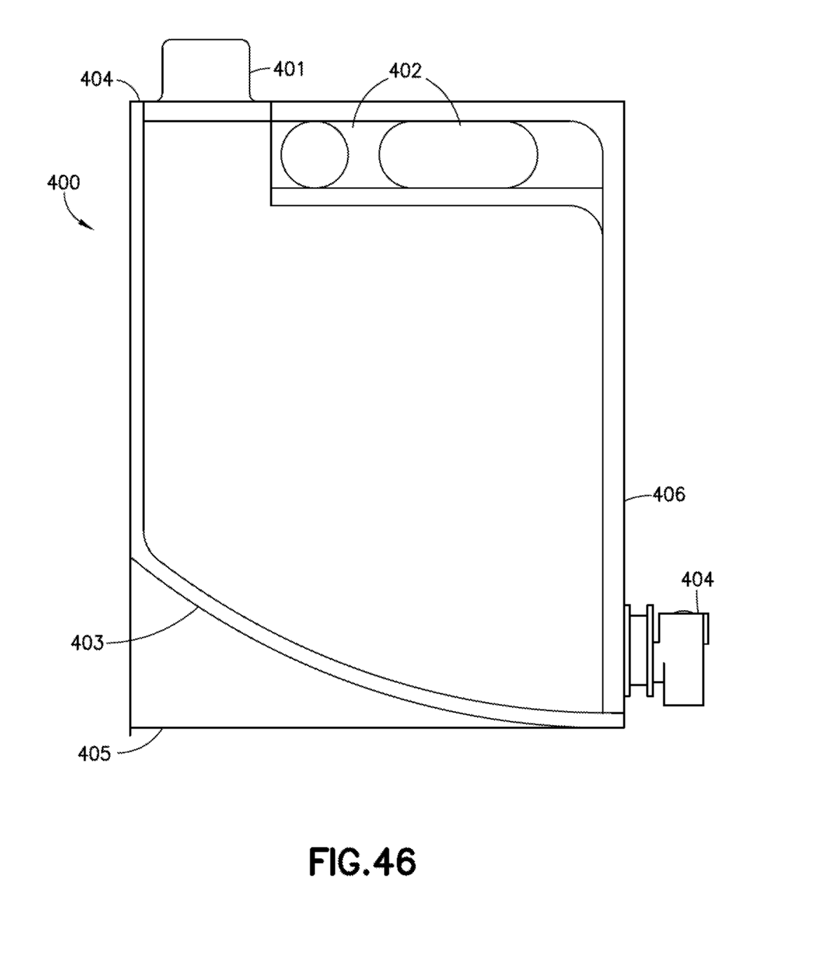

Referring now to FIG. 46, a dual fitment collapsible insert 400 is shown. A fill fitment 401 may be integrated into the top 404 of the collapsible insert 400 and allow for a flowable substance to enter the collapsible insert 400. A pour spout fitment may be integrated into the side 406 of the collapsible insert 400 and allow for a flowable substance to exit the collapsible insert 400. The pour spout fitment 404 may include any suitable valve (not shown) that allows the flowable substance to exit the collapsible insert 400 and block any contaminants from entering the collapsible insert 400. Through-hole handles 402 may be integrated into the collapsible insert 400 and enable the collapsible insert 400 to be easily carried when filled with a flowable substance. An angled seam 403 may be integrated into the collapsible insert 400 and allow the flowable substance to flow towards the pour spout fitment 404. The collapsible insert 400, 250 may be constructed of a food grade laminate heat seal material, or any other suitable material.

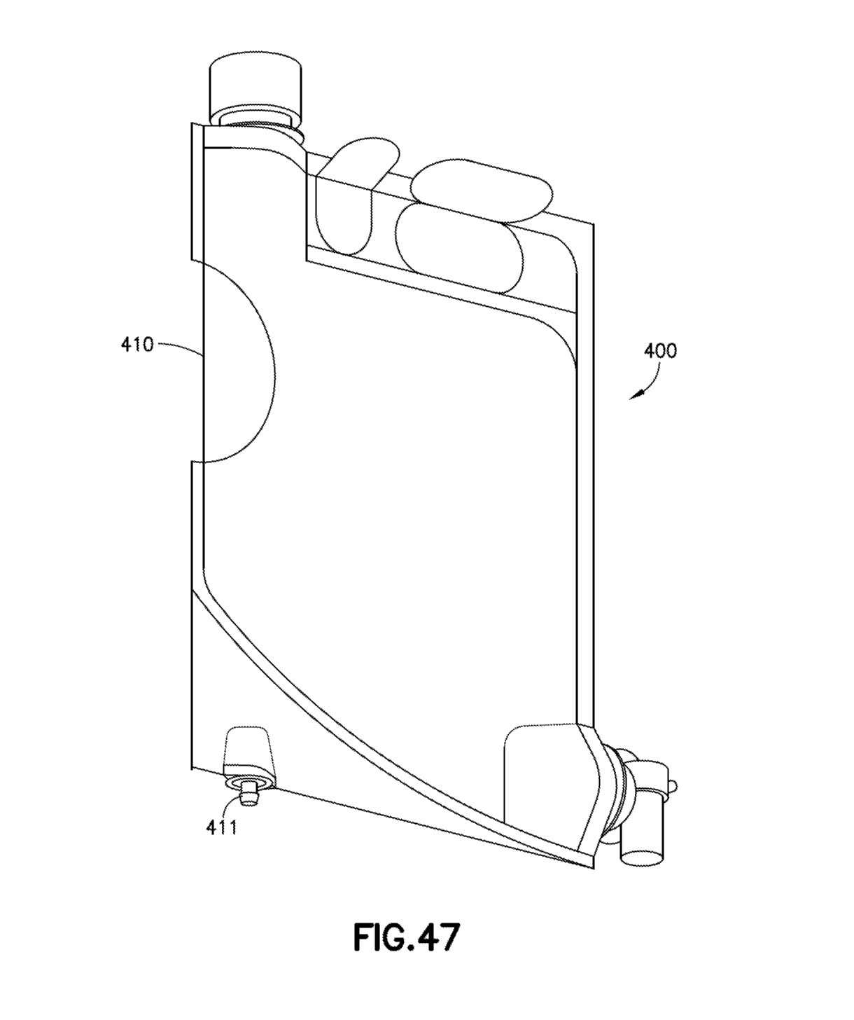

Referring now to FIG. 47, a dual fitment collapsible insert with integrated bladder 410 is shown. The integrated air-bladder 410 may be inflated by attaching a pump (not shown) to the inlet port 411 and incrementally increasing the fluid pressure within the integrated air-bladder 410.

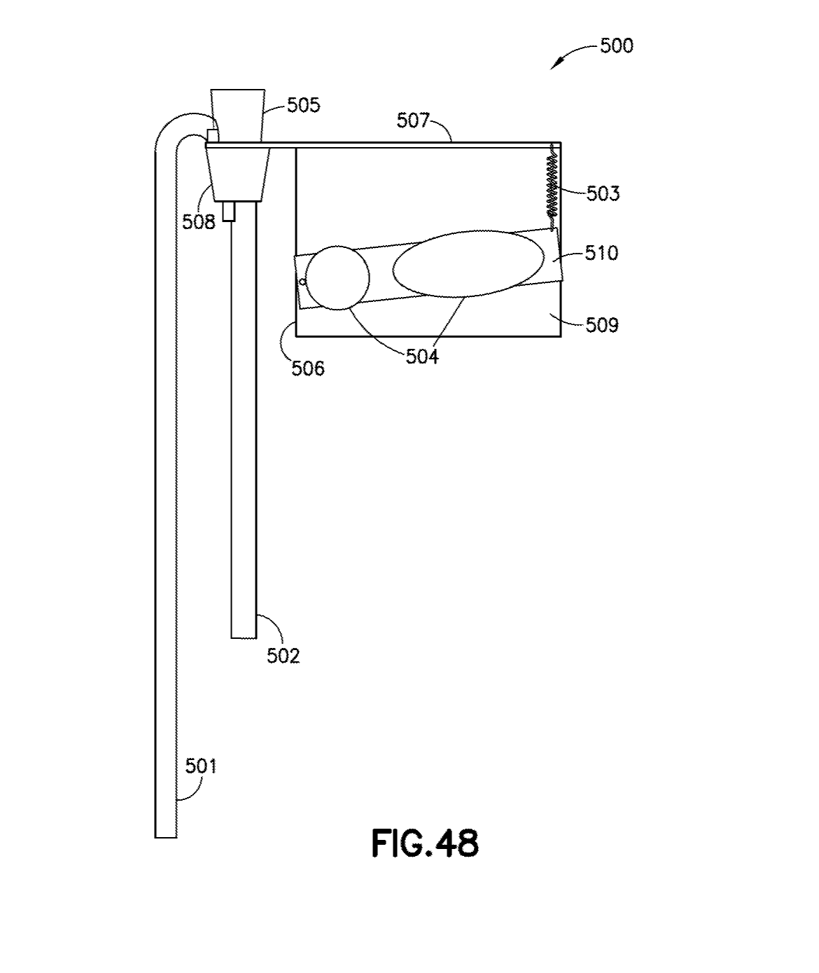

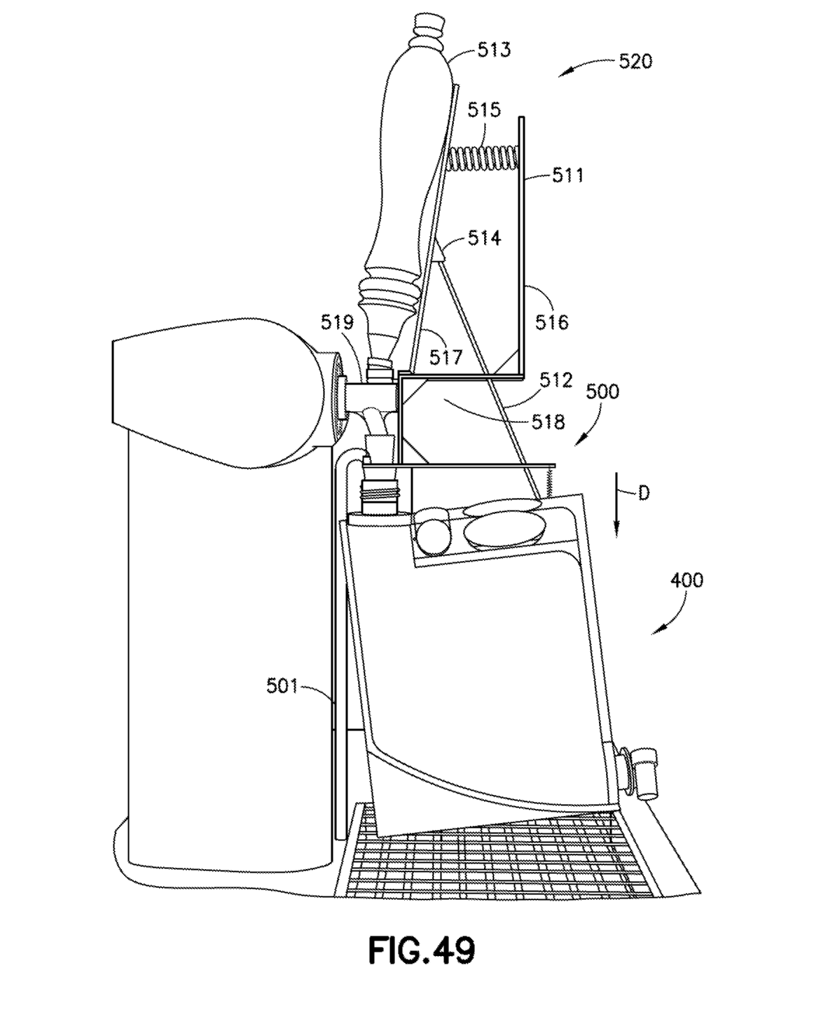

Referring now to FIG. 48, a collapsible insert 400 filling station support structure 500 is shown. A support arm 507 may extend from a tap plug 505 for substantially the same distance as the width of the collapsible insert 400. A plate 509 may be mechanically connected to the support arm 507 and a finger handle plate 510 may be pivotally connected to the plate 509. The finger handles 504 may be mechanically connected to the finger handle plate 510 and may be configured to engage the through-hole handles 402 of the of the collapsible insert 400 such that the support structure 500 can support the weight of a filled collapsible insert 400. A spring 503 may be mechanically connected to the support arm 507 and the finger handle plate 510. The spring 503 may be compressed while the filling station support structure 500 is supporting an empty collapsible insert 400 and the spring 503 may be extended while the filling station support structure 500 is supporting a filled collapsible insert 400. The spring 503 maintains the finger handle plate 510 at a predetermined angle when supporting an empty collapsible insert 400 and the spring 503 may be extended while the finger handle plate 510 pivots on its pivot axis 506. The tap coupling 505 is configured to accept a tap 519 (shown in FIG. 49). The tap 519 may be fitted to the tap coupling 505 forming a seal (not shown) that restricts the flowable substance from leaking out of the tap coupling 505 when the tap 519 is in an open position. A fill fitment coupling 508 may be fitted to the fill fitment 401 of the collapsible insert 400 forming a seal (not shown) that restricts the flowable substance from leaking out of the fill fitment 401 when the tap 519 is in an open position or when there is pressure in the collapsible insert 400 forcing the flowable substance toward the fill fitment. A fill tube 502 may be fitted into the fill fitment coupling 508 and extend from the fill fitment coupling 508 to distance substantially similar to the height of the collapsible insert 400. The fill tube 502 may be inside the collapsible insert 400 while a collapsible insert 400 is being supported by the filling station support structure 500. A drain tube 501 may be fitted into the tap coupling 505 and extend from the tap coupling 505 to a distance greater than the height of the collapsible insert 400. The drain tube 501 may be outside of the collapsible insert 400 while a collapsible insert 400 is being supported by the filling station support structure 500. While the tap 519 is open, the flowable substance may flow from the tap 519 through the tap coupling 505, fitment coupling 508 and the fill tube 502 into the collapsible insert 400. The flowable substance may flow through the fill tube 502, fitment coupling and the drain tube when there is a pressure forcing the flowable substance out of the collapsible insert 400.

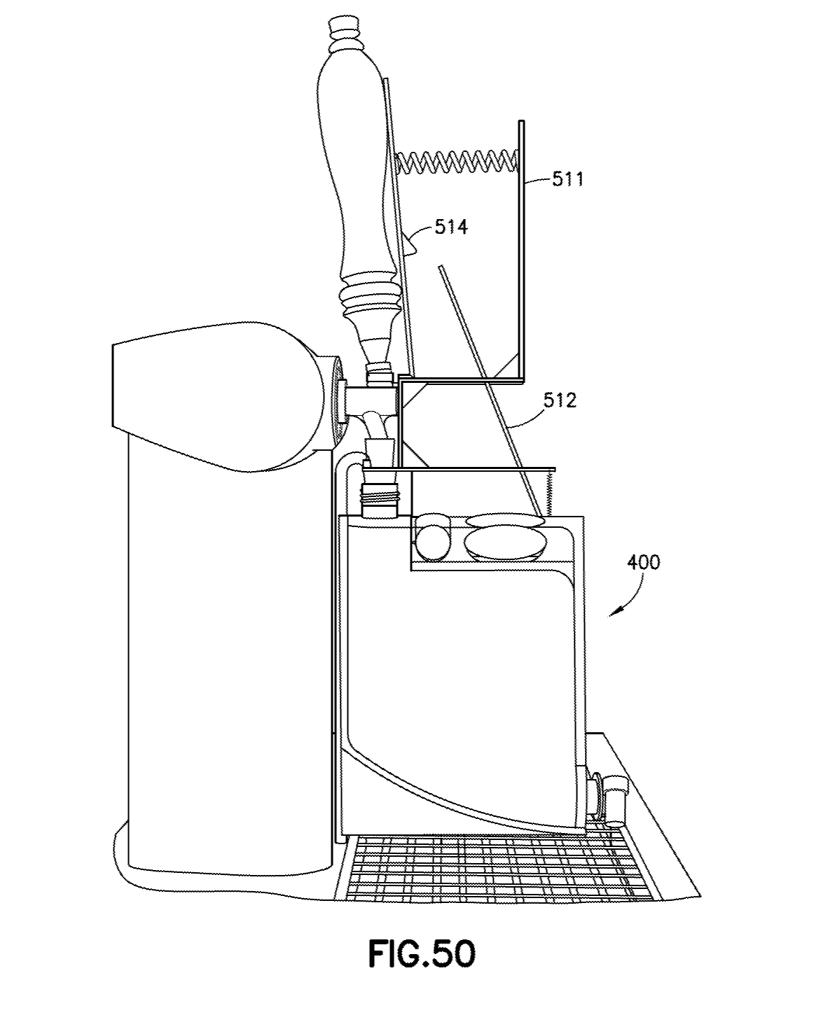

Referring now to FIG. 49, a collapsible insert 400 filling station 520 in the open position is shown. The filling station 520 includes all the features of the filling station support structure 500 described above. A tap on/off switch 511 may be mechanically attached to the tap 519 and the filling station support structure 500. The on/off switch 511 may have a bottom support 518, a fixed support 516, a pivotable support 517, a release coupling 514 and a spring 515. The fixed support 516 is mechanically fixed to the bottom support 518 and the pivotable support 517 is pivotally connected to the bottom support 518. The spring 515 is connected between the fixed support 516 and the pivotable support 517 and is compressed while the tap handle 513 is in an open position and extended when the tap handle 513 is in a closed position. The tap handle 513 controls the opening and closing of the tap valve (not shown). A connecting rod 512 is mechanically connected to the finger handle plate 510 and may be inserted into the release coupling 514 when an empty collapsible insert 400 is being supported by the filling station support structure 500. As the collapsible insert 400 is being filled the finger handle plate 510 may pivot in the downward direction D causing the connecting rod 512 to be released from the release coupling 514 causing the spring 515 to extend causing the tap handle to move from the open position to a closed position as shown in FIG. 50.

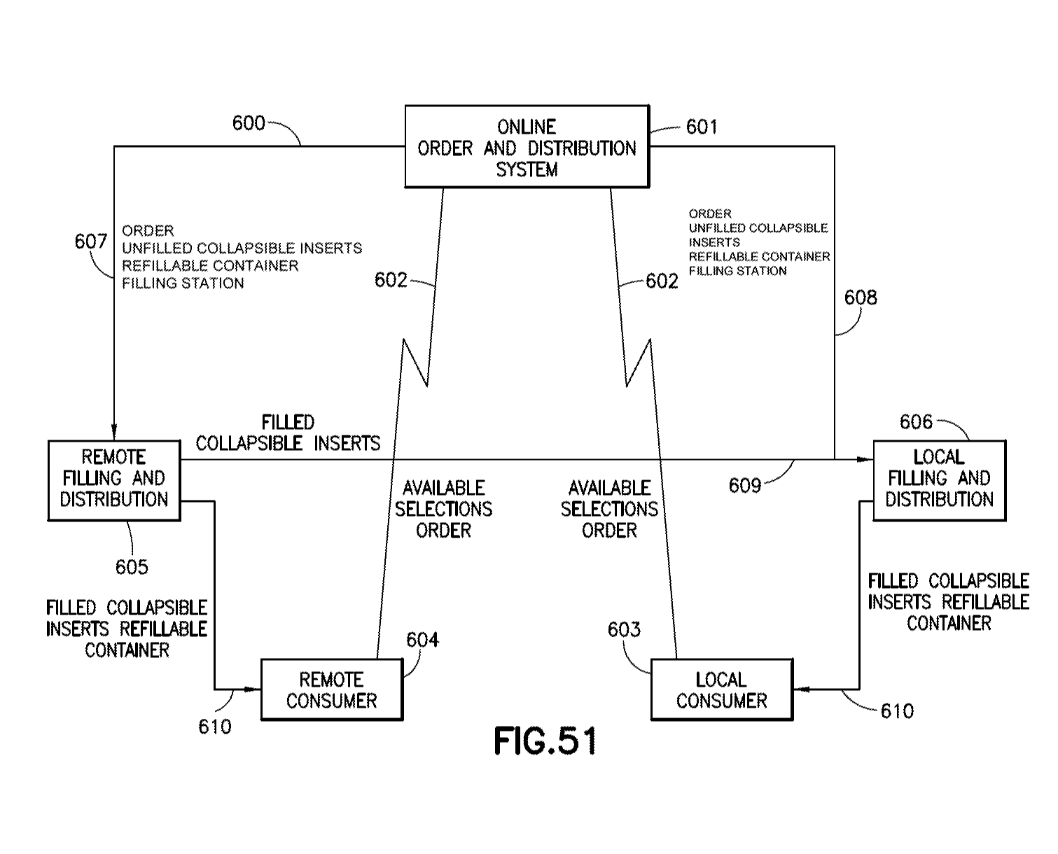

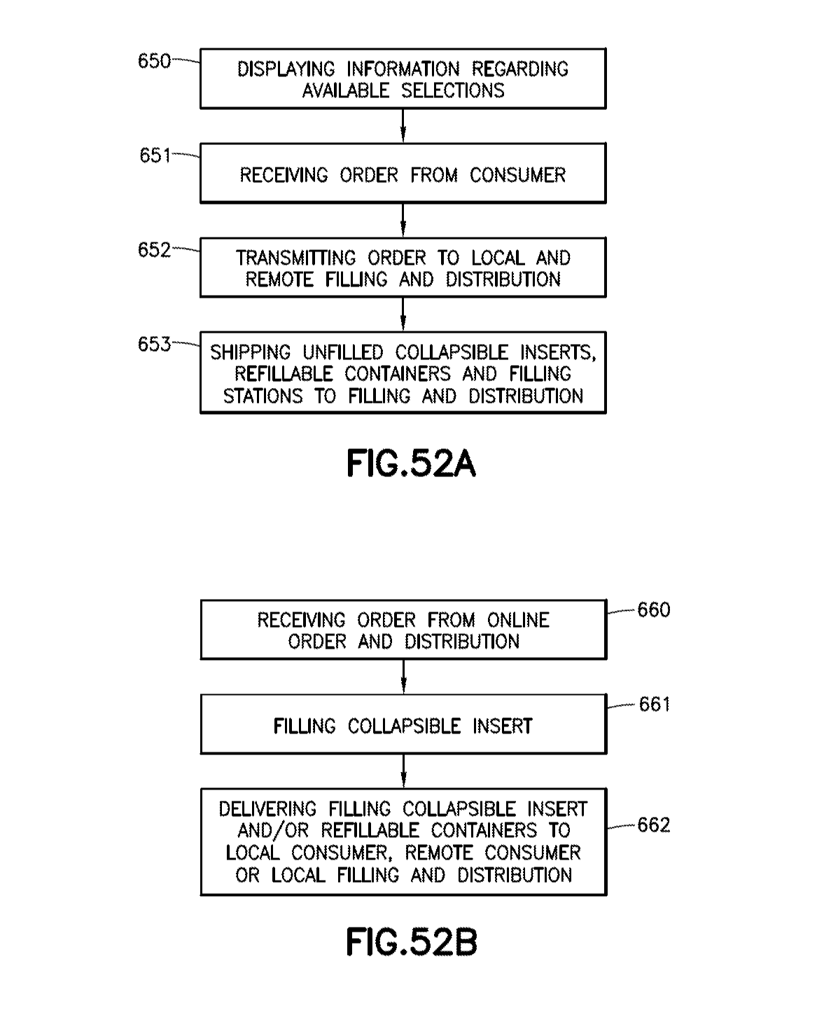

Referring now to FIGS. 51 and 52, a distribution system 600 for distributing filled and unfilled collapsible inserts 400, refillable containers 300, filling station support structures 500 and other related merchandise is shown. An online order and distribution system 601 may provide a consumer 603, 604 with a selection of flowable substances that may be purchased from a remote or local filling and distribution sources 605, 606. The consumer 603, 604 may use a computer, smart phone or any other suitable system to access the online order and distribution system 601 via the internet or any other suitable communications medium 602. The consumer 603, 604 may view the selection of flowable substances and transmit an order request to have the flowable substances distributed directly to the consumer 603, 604 or to the local filling and distribution source 606. The order may be transmitted from the online order and distribution system 601 to the remote or local filling and distribution sources 605, 606. The online order and distribution system 601 may also distribute unfilled collapsible inserts 400, refillable containers 300 and filling station support structures 500 directly to the remote and local filling and distribution sources 605, 606, shown also in FIG. 52A. Upon receipt of an order, the remote filling and distribution source 605 may fill a collapsible insert 400 using the filling station 520, or any other suitable filling method, and distribute the filled collapsible insert to the remote consumer 604 or to the local filling and distribution source 606. The local filling and distribution source 606 may then distribute the filled collapsible insert 400 to the local consumer 603. Upon receipt of an order, the local filling and distribution source 606 may fill a collapsible insert 400 using the filling station 520, or any other suitable filling method, and distribute the filled collapsible insert to the local consumer 603. The online order and distribution system and remote and local filling and distribution sources may distribute refillable containers directly to the consumers 603, 604, shown also in FIG. 52B. Additionally, the unfilled collapsible insert 400, the refillable containers 300 and filling station support structures 500 may arrive at the remote and local filling and distribution sources 605, 606 or the consumers 603, 604 via different distribution paths, and possibly at different arrival times, so that the receipt of the combination of the collapsible inserts 400, refillable containers 300 and the filling support station 500 is responsive to receiving an order from the consumer 603, 604, and 651 for at least one of the available selections 650.

In accordance with one or more aspects of the disclosed embodiment a refillable container, the container includes a semi-rigid outer shell defining an interior void and including one of a detachable pour spout and a discharge cap adjacent to a top end of the shell and a top end of the interior void; and a collapsible insert dimensioned to be selectively secured within the semi-rigid outer shell and removed from the semi-rigid outer shell, the collapsible insert including a securing coupler affixed to a top end of the insert and configured to mechanically engage one of the pour spout and the discharge cap of the semi-rigid outer shell, and the securing coupler also forming a fill fitting configured to mate with an automated filler before the collapsible insert is positioned within the semi-rigid outer shell.

In accordance with one or more aspects of the disclosed embodiment the refillable container further includes a base fixture secured to a bottom end of the collapsible insert opposed to the top end of the insert, the base fixture configured to engage and be selectively secured to a bottom end of the shell to prevent the collapsible insert from collapsing during pouring of a substance within the collapsible insert out of the insert through the securing coupler and pour spout of the shell, the secured base fixture thereby providing zero waste while the substance is poured out of the collapsible insert.

In accordance with one or more aspects of the disclosed embodiment the refillable container, wherein the base fixture is configured to engage and be selectively secured to a top surface of a holding tray for securing a plurality of collapsible inserts during transportation and filling of the collapsible inserts, and wherein the collapsible inserts are configured to be secured to the holding tray in a collapsed mode during transportation of the collapsible inserts.

In accordance with one or more aspects of the disclosed embodiment the refillable container, wherein the securing couplers of the plurality of collapsible inserts are configured to engage and to be selectively secured to a bottom surface of the holding tray.

In accordance with one or more aspects of the disclosed embodiment the refillable container, wherein the plurality of collapsible inserts are secured adjacent each other in a side-by-side arrangement, and wherein the securing couplers of each of the plurality of collapsible inserts are configured to mechanically engage a lift device for lifting the collapsible inserts from a collapsed position to an expanded position.

In accordance with one or more aspects of the disclosed embodiment the refillable container, wherein the pour spout is configured to slidably engage the securing coupler of the collapsible insert to secure the collapsible insert within the interior void of the semi-rigid outer shell.

In accordance with one or more aspects of the disclosed embodiment the refillable container includes at least one helical track defined upon an inside surface of the semi-rigid outer shell so that the helical track revolves about the outer shell from adjacent a shell base upward to pass adjacent the top end of the shell; an elevator platform secured within the outer shell, the elevator platform including at least one pin extending into a track follower, the track follower being slidably secured to the helical track; and a drive mechanism secured within the detachable discharge cap and mechanically engaged with the semi-rigid outer shell whenever the discharge cap is attached to the outer shell for rotating the outer shell relative to the discharge cap to move the pin of the elevator platform and the track follower along the helical track.

In accordance with one or more aspects of the disclosed embodiment the refillable container includes a ratchet mechanism mechanically secured to the drive mechanism to permit only one-way, incremental rotation of the semi-rigid outer shell relative to the discharge cap.

In accordance with one or more aspects of the disclosed embodiment the refillable container, wherein the at least one helical track forms an endless loop from a place of beginning adjacent the shell base and ascends toward the top end of the outer shell through multiple revolutions about the inside surface of the outer shell and the at least one helical track descends from adjacent the top end of the outer shell back to the place of beginning through less than one revolution about the inside surface.

In accordance with one or more aspects of the disclosed embodiment the refillable container, wherein the container includes a compression layer secured between the elevator platform and the collapsible insert that applies constant pressure forcing the collapsible insert toward the top end of the outer shell.

In accordance with one or more aspects of the disclosed embodiment the refillable container includes at least one alignment post extending from the shell base through the elevator platform to the discharge cap to prohibit rotation of the elevator platform relative to the discharge cap.

In accordance with one or more aspects of the disclosed embodiment the refillable container, wherein the discharge cap includes a twist spout mechanically linked to the drive mechanism so that rotation of the twist spout rotates one of the outer shell and the elevator platform.

In accordance with one or more aspects of the disclosed embodiment the refillable container, includes one of the discharge cap having a twist spout, a second discharge cap having an outer cap measuring cup, a third discharge cap having a spray nozzle and an on/off valve, a forth discharge cap including a wide-mouth outlet.

In accordance with one or more aspects of the disclosed embodiment the refillable container, wherein the semi-rigid outer shell includes an integral handle with a trigger extending from the handle and mechanically linked to the drive mechanism.

In accordance with one or more aspects of the disclosed embodiment a refillable container, the container includes: a semi-rigid outer shell defining an interior void and including a detachable pour spout; a collapsible insert dimensioned to be selectively secured within the semi-rigid outer shell and removed from the semi-rigid outer shell, the collapsible insert including a securing coupler affixed to the insert and configured to mechanically engage the pour spout of the semi-rigid outer shell; and a side-force extraction apparatus secured within the interior void and configured to selectively assert compressive force upon the collapsible insert secured adjacent the side-force extraction apparatus, wherein the side-force extraction apparatus include at least one of a first compression plate and a second compression plate adjustably secured to at least one of a first helical axle and a second helical axle, wherein the at least one of the first helical axle and the second helical axle, is secured between a first cover plate and an opposed second cover plate and is mechanically engaged with a driver gear and a ratchet mechanism so that rotation of the driver gear rotates the at least one of the first helical axle and the second helical axle to move the at least one of the first compression plate and the second compression plate toward the collapsible insert.

In accordance with one or more aspects of the disclosed embodiment the refillable container, wherein the semi-rigid outer shell is secured between a first pivot base and a second pivot base to permit pivoting of the outer shell between a dispensing mode and a refill mode.

In accordance with one or more aspects of the disclosed embodiment a refillable container, the container includes a semi-rigid outer shell defining an interior void; a collapsible insert configured to be selectively secured within the semi-rigid outer shell and removed from the semi-rigid outer shell, the collapsible insert including a fill fitment, a pour spout fitment and a securing coupler affixed to the collapsible insert and configured to mechanically engage the semi-rigid outer shell; and a side-force extraction apparatus secured within the interior void and configured to selectively assert compressive force upon the collapsible insert secured adjacent to the side-force extraction apparatus, wherein the side-force extraction apparatus includes at least one of a first air bladder secured between a first side wall of the semi-rigid outer shell and a first side of the collapsible insert and a second air bladder secured between a second side wall of the semi-rigid outer shell and a side of the collapsible insert, and a fluid pump control apparatus and pump actuator configured for selectively admitting a fluid into the at least one of the first air bladder and the second air bladder to selectively compress the collapsible insert.

In accordance with one or more aspects of the disclosed embodiment the refillable container, includes a pressure sensor configured to measure a pressure inside the collapsible insert and provide a pressure measurement value to the fluid pump control apparatus to control the pump actuator.

In accordance with one or more aspects of the disclosed embodiment the refillable container includes a user display configured to display the pressure inside the collapsible insert and set a preset pressure to be used by the fluid pump control apparatus to control the pump actuator.

In accordance with one or more aspects of the disclosed embodiment a collapsible insert for retaining a flowable substance includes a first laminate sheet and a second laminate sheet, wherein the first laminate sheet is heat sealed to the second laminate sheet forming a sealed enclosure, the sealed enclosure having a top, bottom, first sheet side, second sheet side, first sealed side and second sealed side; a fill fitment integrated into the top of the sealed enclosure; a pour spout fitment integrated into one of the sealed sides and located substantially close the bottom of the sealed enclosure; an angled seam extending from one of the sealed sides towards the pour spout fitment forcing the flowable substance to flow towards the pour spout fitment; a through-hole handle integrated into the collapsible insert and configured to support the weight of the collapsible insert when filled with the flowable substance.

In accordance with one or more aspects of the disclosed embodiment a filling station for filling a collapsible insert with a flowable substance includes a collapsible insert; a support structure configured to support the collapsible insert; a tap configured to flow the flowable substance into the collapsible insert; a tap on/off switch configured to be set on when the tap is in an open position and flowing the flowable substance into the collapsible insert and set off when the collapsible insert is filled with the flowable substance, wherein the tap on/off switch causes the tap to be moved to an off position when the tap on/off switch is set to off.

In accordance with one or more aspects of the disclosed embodiment the filling station for filling a collapsible insert with a flowable substance includes a drain tube configured to allow the flowable substance to flow from the collapsible insert.

In accordance with one or more aspects of the disclosed embodiment the filling station for filling a collapsible insert with a flowable substance includes a fill tube configured to allow the flowable substance to flow into the collapsible insert.

In accordance with one or more aspects of the disclosed embodiment a filling station kit includes a collapsible insert; a support structure configured to support the collapsible insert; a tap on/off switch configured to be set on when a tap is in an open position and flowing a flowable substance into the collapsible insert and set off when the collapsible insert is filled with the flowable substance, wherein the tap on/off switch causes the tap to be moved to an off position when the tap on/off switch is set to off.

In accordance with one or more aspects of the disclosed embodiment a method for remotely distributing flowable substances includes displaying, on an online order and distribution system, selections of flowable substances; receiving, on the online order and distribution system, an order from a consumer; transmitting the order to one of a remote or local filling and distribution sources; providing, in response to the order, in combination, at least one unfilled collapsible inserts, at least one refillable containers and at least one station support structures; distributing the unfilled collapsible inserts, refillable containers and station support structures from the online order and distribution system to one of the remote or local filling and distribution sources; receiving the order from the online order and distribution system at one of the remote or local filling and distribution sources; filling the collapsible insert at one of the remote or local filling and distribution sources; delivering the filled collapsible inserts from the remote filling and distribution source to the local filling and distribution source or delivering the filled collapsible inserts and the refillable containers from one of the remote and local filling and distribution sources to the consumer.

In accordance with one or more aspects of the disclosed embodiment a method of manufacturing a collapsible insert including joining a predetermined number of securing couplers to a same predetermined number of flexible bodies to form a predetermined number of joined collapsible inserts, wherein the collapsible inserts are configured to contain a product, and are configured to be secured to each other in a side-by-side arrangement; securing the predetermined number of joined collapsible inserts within a top surface of a holding tray; collapsing the predetermined number of joined collapsible inserts unto the top surface of the holding tray to form a first set of collapsed collapsible inserts; and transporting the first set of collapsed collapsible inserts on the holding tray from a place of manufacture of the first set to a place of filling the first set of collapsible inserts.

In accordance with one or more aspects of the disclosed embodiment the method of manufacturing collapsible inserts includes after the transporting the first set of collapsed collapsible inserts to the place of filling step, engaging a lift device with the securing couplers of the first set of collapsible inserts to expand the inserts from a collapsed position to an expanded position, and then inserting an automated fill device through the securing couplers to fill the collapsible inserts with a product while the collapsible inserts remain secured within the holding tray.

While the present disclosure has been presented above with respect to the described and illustrated embodiments of the refillable containers 20, 100, 240 and 300 with a zero waste dispensing system, it is to be understood that the disclosure is not to be limited to those illustrations and described embodiments. Accordingly, reference should be made primarily to the following claims rather than the forgoing description to determine the scope of the disclosure.

What is claimed is:

1. A refillable container, the container comprising:
a semi-rigid outer shell defining an interior void and including one of a detachable pour spout and a discharge cap adjacent to a top end of the shell and a top end of the interior void;
a collapsible insert dimensioned to be selectively secured within the semi-rigid outer shell and removed from the semi-rigid outer shell, the collapsible insert including a securing coupler affixed to a top end of the insert and configured to mechanically engage one of the pour spout and the discharge cap of the semi-rigid outer shell, and the securing coupler also forming a fill fitting configured to mate with an automated filler before the collapsible insert is positioned within the semi-rigid outer shell.

2. The refillable container of claim 1, further comprising a base fixture secured to a bottom end of the collapsible insert opposed to the top end of the insert, the base fixture configured to engage and be selectively secured to a bottom end of the shell to prevent the collapsible insert from collapsing during pouring of a substance within the collapsible insert out of the insert through the securing coupler and pour spout of the shell, the secured base fixture thereby providing zero waste while the substance is poured out of the collapsible insert.

3. The refillable container of claim 2, wherein the base fixture is configured to engage and be selectively secured to a top surface of a holding tray for securing a plurality of collapsible inserts during transportation and filling of the collapsible inserts, and wherein the collapsible inserts are configured to be secured to the holding tray in a collapsed mode during transportation of the collapsible inserts.

4. The refillable container of claim 3, wherein the securing couplers of the plurality of collapsible inserts are configured to engage and to be selectively secured to a bottom surface of the holding tray.

5. The refillable container of claim 3, wherein the plurality of collapsible inserts are secured adjacent each other in a side-by-side arrangement, and wherein the securing couplers of each of the plurality of collapsible inserts are configured to mechanically engage a lift device for lifting the collapsible inserts from a collapsed position to an expanded position.

6. The refillable container of claim 1, wherein the pour spout is configured to slidably engage the securing coupler of the collapsible insert to secure the collapsible insert within the interior void of the semi-rigid outer shell.

7. The refillable container of claim 1, further comprising:
at least one helical track defined upon an inside surface of the semi-rigid outer shell so that the helical track revolves about the outer shell from adjacent a shell base upward to pass adjacent the top end of the shell;
an elevator platform secured within the outer shell, the elevator platform including at least one pin extending into a track follower, the track follower being slidably secured to the helical track; and
a drive mechanism secured within the detachable discharge cap and mechanically engaged with the semi-rigid outer shell whenever the discharge cap is attached to the outer shell for rotating the outer shell relative to the discharge cap to move the pin of the elevator platform and the track follower along the helical track.

8. The refillable container of claim 7, further comprising a ratchet mechanism mechanically secured to the drive mechanism to permit only one-way, incremental rotation of the semi-rigid outer shell relative to the discharge cap.

9. The refillable container of claim 8, wherein the at least one helical track forms an endless loop from a place of beginning adjacent the shell base and ascends toward the top end of the outer shell through multiple revolutions about the inside surface of the outer shell and the at least one helical track descends from adjacent the top end of the outer shell back to the place of beginning through less than one revolution about the inside surface.

10. The refillable container of claim 8, wherein the container further comprises a compression layer secured between the elevator platform and the collapsible insert that applies constant pressure forcing the collapsible insert toward the top end of the outer shell.

11. The refillable container of claim 8, further comprising at least one alignment post extending from the shell base through the elevator platform to the discharge cap to prohibit rotation of the elevator platform relative to the discharge cap.

12. The refillable container of claim 8, wherein the discharge cap includes a twist spout mechanically linked to the drive mechanism so that rotation of the twist spout rotates one of the outer shell and the elevator platform.

13. The refillable container of claim 8, further comprising one of the discharge cap having a twist spout, a second discharge cap having an outer cap measuring cup, a third discharge cap having a spray nozzle and an on/off valve, a forth discharge cap including a wide-mouth outlet.

14. The refillable container of claim 8, wherein the semi-rigid outer shell includes an integral handle with a trigger extending from the handle and mechanically linked to the drive mechanism.

15. A refillable container, the container comprising:
a semi-rigid outer shell defining an interior void and including a detachable pour spout;
a collapsible insert dimensioned to be selectively secured within the semi-rigid outer shell and removed from the semi-rigid outer shell, the collapsible insert including a securing coupler affixed to the insert and configured to mechanically engage the pour spout of the semi-rigid outer shell; and
a side-force extraction apparatus secured within the interior void and configured to selectively assert compressive force upon the collapsible insert secured adjacent the side-force extraction apparatus, wherein the side-force extraction apparatus include at least one of a first compression plate and a second compression plate adjustably secured to at least one of a first helical axle and a second helical axle, wherein the at least one of the first helical axle and the second helical axle, is secured between a first cover plate and an opposed second cover plate and is mechanically engaged with a driver gear and a ratchet mechanism so that rotation of the driver gear rotates the at least one of the first helical axle and the second helical axle to move the at least one of the first compression plate and the second compression plate toward the collapsible insert.

16. The refillable container of claim 15, wherein the semi-rigid outer shell is secured between a first pivot base and a second pivot base to permit pivoting of the outer shell between a dispensing mode and a refill mode.

17. A refillable container, the container comprising:
a semi-rigid outer shell defining an interior void;
a collapsible insert configured to be selectively secured within the semi-rigid outer shell and removed from the semi-rigid outer shell, the collapsible insert including a fill fitment, a pour spout fitment and a securing coupler affixed to the collapsible insert and configured to mechanically engage the semi-rigid outer shell; and
a side-force extraction apparatus secured within the interior void and configured to selectively assert compressive force upon the collapsible insert secured adjacent to the side-force extraction apparatus, wherein the side-force extraction apparatus includes at least one of a first air bladder secured between a first side wall of the semi-rigid outer shell and a first side of the collapsible insert and a second air bladder secured between a second side wall of the semi-rigid outer shell and a side of the collapsible insert, and a fluid pump control apparatus and pump actuator configured for selectively admitting a fluid into the at least one of the first air bladder and the second air bladder to selectively compress the collapsible insert.

18. The refillable container of claim 17, further comprising a pressure sensor configured to measure a pressure inside the collapsible insert and provide a pressure measurement value to the fluid pump control apparatus to control the pump actuator.

19. The refillable container of claim 18, further comprising a user display configured to display the pressure inside the collapsible insert and set a preset pressure to be used by the fluid pump control apparatus to control the pump actuator.

20. A collapsible insert for retaining a flowable substance comprising:
a first laminate sheet and a second laminate sheet, wherein the first laminate sheet is heat sealed to the second laminate sheet forming a sealed enclosure, the sealed enclosure having a top, bottom, first sheet side, second sheet side, first sealed side and second sealed side;
a fill fitment integrated into the top of the sealed enclosure;
a pour spout fitment integrated into one of the sealed sides and located substantially close the bottom of the sealed enclosure;
an angled seam extending from one of the sealed sides towards the pour spout fitment forcing the flowable substance to flow towards the pour spout fitment;
a through-hole handle integrated into the collapsible insert and configured to support the weight of the collapsible insert when filled with the flowable substance.

21. A filling station for filling a collapsible insert with a flowable substance comprising:
a collapsible insert;
a support structure configured to support the collapsible insert;
a tap configured to flow the flowable substance into the collapsible insert;
a tap on/off switch configured to be set on when the tap is in an open position and flowing the flowable substance into the collapsible insert and set off when the collapsible insert is filled with the flowable substance, wherein the tap on/off switch causes the tap to be moved to an off position when the tap on/off switch is set to off.

22. The filling station for filling a collapsible insert with a flowable substance of claim 21, further comprising a drain tube configured to allow the flowable substance to flow from the collapsible insert.

23. The filling station for filling a collapsible insert with a flowable substance of claim 21, further comprising a fill tube configured to allow the flowable substance to flow into the collapsible insert.

24. A filling station kit comprising:
a collapsible insert;
a support structure configured to support the collapsible insert;
a tap on/off switch configured to be set on when a tap is in an open position and flowing a flowable substance into the collapsible insert and set off when the collapsible insert is filled with the flowable substance, wherein the tap on/off switch causes the tap to be moved to an off position when the tap on/off switch is set to off.

25. A method for remotely distributing flowable substances comprising:
displaying, on an online order and distribution system, selections of flowable substances;
receiving, on the online order and distribution system, an order from a consumer;
transmitting the order to one of a remote or local filling and distribution sources;
providing, in response to the order, in combination, at least one unfilled collapsible inserts, at least one refillable containers and at least one station support structures;
distributing the unfilled collapsible inserts, refillable containers and station support structures from the online order and distribution system to one of the remote or local filling and distribution sources;
receiving the order from the online order and distribution system at one of the remote or local filling and distribution sources;
filling the collapsible insert at one of the remote or local filling and distribution sources;
delivering the filled collapsible inserts from the remote filling and distribution source to the local filling and distribution source or delivering the filled collapsible inserts and the refillable containers from one of the remote and local filling and distribution sources to the consumer.

26. A method of manufacturing a collapsible insert, the method including:
joining a predetermined number of securing couplers to a same predetermined number of flexible bodies to form a predetermined number of joined collapsible inserts, wherein the collapsible inserts are configured to contain a product, and are configured to be secured to each other in a side-by-side arrangement;
securing the predetermined number of joined collapsible inserts within a top surface of a holding tray;
collapsing the predetermined number of joined collapsible inserts unto the top surface of the holding tray to form a first set of collapsed collapsible inserts; and
transporting the first set of collapsed collapsible inserts on the holding tray from a place of manufacture of the first set to a place of filling the first set of collapsible inserts.

27. The method of manufacturing collapsible inserts of claim 26, further comprising, after the transporting the first set of collapsed collapsible inserts to the place of filling step, engaging a lift device with the securing couplers of the first set of collapsible inserts to expand the inserts from a collapsed position to an expanded position, and then inserting an automated fill device through the securing couplers to fill the collapsible inserts with a product while the collapsible inserts remain secured within the holding tray.
